(19) United States
(12) Patent Application Publication
(10) Pub. No.: US 2025/0239017 A1
(43) Pub. Date: Jul. 24, 2025

(54) IMPLICIT SOLID SHAPE MODELING USING CONSTRUCTIVE SOLID GEOMETRY

(71) Applicant: Roblox Corporation, San Mateo, CA (US)

(72) Inventors: Hsueh-Ti Derek Liu, Vancouver (CA); Maneesh Agrawala, San Mateo, CA (US); Cem Yuksel, Salt Lake City, UT (US); Timothy Paul Omernick, San Diego, CA (US); Vinith Misra, San Mateo, CA (US); Stefano Corazza, Greenbrae, CA (US); Morgan Samuel McGuire, Waterloo (CA); Victor B. Zordan, Riverside, CA (US)

(73) Assignee: Roblox Corporation, San Mateo, CA (US)

(21) Appl. No.: 18/770,779

(22) Filed: Jul. 12, 2024

Related U.S. Application Data
(60) Provisional application No. 63/624,146, filed on Jan. 23, 2024.

(51) Int. Cl. G06T 17/10; G06T 17/00

(52) U.S. Cl. CPC G06T 17/10; G06T 17/005

(57) ABSTRACT

Some implementations relate to methods, systems, and computer-readable media for generating a constructive solid geometry (CSG) model. A groundtruth occupancy function descriptive of a three-dimensional (3D) object is obtained. A constructive solid geometry (CSG) model of the 3D object is constructed. The CSG model is defined by a binary tree wherein nodes of the binary tree define Boolean operations and leaves of the binary tree define parameters of CSG primitives, wherein values of the Boolean operations and values of the parameters of the CSG primitives for the binary tree are identified by minimizing an error between an occupancy function of the CSG model and the groundtruth occupancy function of the 3D object. The Boolean operations may correspond to unified fuzzy Boolean operators that are differentiable with respect to a type of Boolean operator.

### CROSS-REFERENCE TO RELATED APPLICATIONS

This application claims priority to U.S. Provisional Application No. 63/624,146, entitled “AUTOMATIC CONVERSION OF THREE-DIMENSIONAL OBJECT MODELS,” filed on Jan. 23, 2024, the content of which is incorporated herein in its entirety.

### TECHNICAL FIELD

Implementations relate generally to computer graphics, and more particularly to systems, methods, and computer-readable media to automatically perform solid shape modeling using constructive solid geometry (CSG).

### BACKGROUND

A number of techniques have been developed and are used to generate three-dimensional (3D) models for game development. One widely used approach to creating a 3D model is to construct a mesh of a three-dimensional structure. Developers build landscapes, buildings, props, and other objects by assembling and modifying meshes. A 3D model may include a mesh and information about one or more model surfaces.

A mesh specifies a set of vertices and edges (that may form one or more faces) that define the shape and structure of a 3D object. Meshes are often represented using polygons, most commonly triangles. The faces of a mesh may be composed of triangular polygons.

A 3D model also stores information about the surface of a 3D object. Such information may include material properties such as color, texture coordinates, normals, and more. Texture coordinates may be usable to automatically to map textures onto the mesh, giving the 3D object a particular appearance. Surface normals define the direction each face is facing, enabling proper shading and lighting calculations.

Meshes may be used in virtual environments to render one or more virtual objects. Meshes may also be used to render virtual avatars or characters. A developer may rig an avatar mesh by defining a skeletal structure or armature. By assigning weights to vertices, the mesh is configured to deform smoothly as the underlying skeleton moves, resulting in high quality animations.

Another technique used in gaming development to create 3D models is known as constructive solid geometry (CSG). In CSG, the basic building blocks are simple geometric shapes (such as cubes, spheres, cylinders, cones, etc.) referred to as primitives. Complex objects are created by combining primitives using Boolean operations (e.g., union, intersection, and difference). CSG permits developers to create and modify game environments quickly and efficiently by using primitives as building blocks and combining the primitives to form complex structures like buildings, rooms, or landscapes. CSG is also used for avatar animation in some gaming and virtual reality environments.

CSG offers a hierarchical representation with precise and fabricable parts, making CSG a widely used tool in Computer Aided Design (CAD). The simplicity of creating 3D objects by assembling primitives also makes CSG an attractive candidate for creating 3D content.

This use of continuous primitive representations enables continuous optimization techniques (e.g., gradient descent) to be deployed in a part of inverse CSG optimization, but not the entire tree. Such a formulation still possesses discrete variables—the Boolean operations. This limitation results in either having a big discrete search space or the task of pre-determining the Boolean operations (e.g., start with performing a set of intersections and follow by performing a set of unions) in order to optimize the primitive parameters.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing are neither expressly or impliedly admitted as prior art against the prior disclosure.

### SUMMARY

Implementations of this application relate to automatic conversion of three-dimensional object models.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method comprises obtaining a groundtruth occupancy function descriptive of a three-dimensional (3D) object; and constructing a constructive solid geometry (CSG) model of the 3D object, the CSG model defined by a binary tree wherein nodes of the binary tree define Boolean operations and leaves of the binary tree define parameters of CSG primitives, wherein values of the Boolean operations and values of the parameters of the CSG primitives for the binary tree are identified by minimizing an error between an occupancy function of the CSG model and the groundtruth occupancy function of the 3D object.

Various implementations of the computer-implemented method are described herein.

In some implementations, the Boolean operations correspond to unified fuzzy Boolean operators that are differentiable with respect to a type of Boolean operator.

In some implementations, the unified fuzzy Boolean operators are defined by a tetrahedral barycentric interpolation scheme, based on barycentric coordinates that specify a position between binary Boolean operations that define a tetrahedron.

In some implementations, the CSG primitives are smooth primitives and the CSG model has an adaptive smoothness controlled by changing respective softness of occupancy functions of the smooth primitives.

In some implementations, the CSG primitives are represented as signed distance functions, and the computer-implemented method further comprises converting the signed distance functions into occupancy functions using a sigmoid function based on a sharpness parameter.

In some implementations, the respective softness of the occupancy functions of the smooth primitives is controlled by a temperature parameter of the sigmoid function.

In some implementations, the groundtruth occupancy function of the 3D object is obtained from a visual hull representation of the 3D object that is generated based on a mesh corresponding to the 3D object.

In some implementations, the computer-implemented method further comprises initializing the binary tree with random parameter values, and wherein minimizing the error comprises iteratively modifying the values of the Boolean operations and the values of the parameters of the CSG primitives in the binary tree until the error between the occupancy function of the CSG model and the groundtruth occupancy function of the 3D object is less than a threshold value.

In some implementations, minimizing the error is performed using adaptive moment estimation (ADAM).

In some implementations, the CSG primitives are selected from the group comprising: spheres, planes, quadric surfaces, multilayer perceptrons (MLPs), and combinations thereof.

In some implementations, minimizing the error between an occupancy function of the CSG model and the groundtruth occupancy function of the 3D object comprises updating the values of the Boolean operations and the values of the parameters of the CSG primitives for the binary tree using a machine learning model, wherein the updating comprises: determining the occupancy function of the CSG model based on the values of the Boolean operations and parameters of the CSG primitives of the CSG model; computing a difference between the occupancy function of the CSG model and the groundtruth occupancy function of the 3D object; and modifying values of the Boolean operations and parameters of the CSG primitives of the CSG model based on the difference, wherein the modifying is performed using gradient descent, wherein the determining, computing, and modifying are performed iteratively until a stopping criterion is met, wherein the stopping criterion is at least one of: the difference between the occupancy function of the CSG model and the groundtruth occupancy function of the 3D object falling below a threshold, change between the occupancy function of the CSG model between consecutive iterations falling below a change threshold, or a computational budget being exhausted.

In some implementations, computing the difference comprises: sampling the groundtruth occupancy of the 3D object to identify a plurality of groundtruth points; determining corresponding modeled points obtained based on the CSG model; and computing an error by pairwise comparison of points from the plurality of groundtruth points and corresponding modeled points.

In some implementations, the gradient descent uses Boolean parameterization based on a temperatured SoftMax function to facilitate convergence for the Boolean operations to a single Boolean logic operation.

In some implementations, the computer-implemented method further comprises pruning the binary tree to remove redundant subtrees to obtain a pruned binary tree by visiting nodes in the tree in post-order and deleting redundant nodes, wherein a node is redundant when replacement of the node with a full object or an empty object results in a difference in an output of a Boolean operation associated with the node in the binary tree that satisfies a threshold.

In some implementations, the computer-implemented method further comprises traversing the pruned binary tree using a linear time traversal algorithm on a forward pass in post-order using a stack when using the pruned binary tree to infer properties of the CSG model of the 3D object.

According to another aspect, a non-transitory computer-readable medium is provided. The non-transitory computer-readable medium has instructions stored thereon that, responsive to execution by a processing device, cause the processing device to perform operations comprising: obtaining a groundtruth occupancy function descriptive of a three-dimensional (3D) object; and constructing a constructive solid geometry (CSG) model of the 3D object, the CSG model defined by a binary tree wherein nodes of the binary tree define Boolean operations and leaves of the binary tree define parameters of CSG primitives, wherein values of the Boolean operations and values of the parameters of the CSG primitives for the binary tree are identified by minimizing an error between an occupancy function of the CSG model and the groundtruth occupancy function of the 3D object.

Various implementations of the non-transitory computer-readable medium are described herein.

In some implementations, the Boolean operations correspond to unified fuzzy Boolean operators that are differentiable with respect to a type of Boolean operator.

In some implementations, the operations further comprise initializing the binary tree with random parameter values, and wherein minimizing the error comprises iteratively modifying the values of the Boolean operations and the values of the parameters of the CSG primitives in the binary tree until the error between the occupancy function of the CSG model and the groundtruth occupancy function of the 3D object is less than a threshold value.

According to another aspect, a system is disclosed, comprising: a memory with instructions stored thereon; and a processing device, coupled to the memory, the processing device configured to access the memory and execute the instructions, wherein the instructions cause the processing device to perform operations comprising: obtaining a groundtruth occupancy function descriptive of a three-dimensional (3D) object; and constructing a constructive solid geometry (CSG) model of the 3D object, the CSG model defined by a binary tree wherein nodes of the binary tree define Boolean operations and leaves of the binary tree define parameters of CSG primitives, wherein values of the Boolean operations and values of the parameters of the CSG primitives for the binary tree are identified by minimizing an error between an occupancy function of the CSG model and the groundtruth occupancy function of the 3D object.

Various implementations of the system are described herein.

In some implementations, the Boolean operations correspond to unified fuzzy Boolean operators that are differentiable with respect to a type of Boolean operator.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF DRAWINGS

FIG. 1 is a diagram of an example system architecture in which solid shape modeling using constructive solid geometry (CSG) is performed, in accordance with some implementations.

FIG. 2A illustrates components of a virtual experience server, in accordance with some implementations.

FIG. 2B illustrates a flowchart of an example method to generate a constructive solid geometry (CSG) model from a 3D model, in accordance with some implementations.

FIG. 3A illustrates an example method of generating a constructive solid geometry (CSG) model, in accordance with some implementations.

FIG. 3B illustrates components of a mesh-based model, in accordance with some implementations.

FIG. 3C illustrates the use of a mesh-based model(s) as the basis of a visual hull, in accordance with some implementations.

FIG. 3D illustrates an example method to generate a constructive solid geometry (CSG) model, in accordance with some implementations.

FIG. 4A illustrates an example method to convert a mesh-based model to a constructive solid geometry (CSG) model, in accordance with some implementations.

FIG. 4B illustrates another example method to convert a mesh-based model to a constructive solid geometry (CSG) model, in accordance with some implementations.

FIG. 5 illustrates constructive solid geometry (CSG) models based on classic Boolean operations and CSG models based on continuous Boolean operations, in accordance with some implementations.

FIG. 6 illustrates a visualization of a unified continuous Boolean operation, in accordance with some implementations.

FIG. 7 illustrates several examples of fitting a shape with constructive solid geometry (CSG) via gradient descent and different primitives, in accordance with some implementations.

FIG. 8 illustrates comparison between an object constructed using a binary tree and a corresponding groundtruth object, in accordance with some implementations.

FIG. 9 illustrates an example method to build a binary tree from a groundtruth object, in accordance with some implementations.

FIG. 10 illustrates a block diagram to optimize a binary tree using a method, in accordance with some implementations.

FIG. 11 illustrates an example of pruning a binary tree, in accordance with some implementations.

FIG. 12A illustrates an example of a pipeline to perform inverse constructive solid geometry (CSG) fitting, in accordance with some implementations.

FIG. 12B illustrates inverse CSG fitting according to various techniques for some example objects, in accordance with some implementations.

FIG. 13 illustrates the use of various types of Boolean operators, in accordance with some implementations.

FIG. 14 illustrates aspects of avoiding vanishing gradients, in accordance with some implementations.

FIG. 15 illustrates aspects of naïve bilinear interpolation, in accordance with some implementations.

FIG. 16 illustrates a groundtruth shape and a corresponding constructive solid geometry (CSG) shape, in accordance with some implementations.

FIG. 17 illustrates an example of a soft blending result that includes artifacts and another soft blending result that is free from artifacts, in accordance with some implementations.

FIG. 18 illustrates examples of hard and adaptive smoothness in constructive solid geometry (CSG), in accordance with some implementations.

FIG. 19 illustrates examples of various types of fitting, in accordance with some implementations.

FIG. 20 illustrates examples of fitting objects to groundtruth shapes, in accordance with some implementations.

FIG. 21 illustrates an example of building a binary tree, in accordance with some implementations.

FIG. 22 illustrates example inputs in the training of a neural network, in accordance with some embodiments.

FIG. 23 illustrates an example inference model that can take multiple and heterogeneous inputs, in accordance with some implementations.

FIG. 24 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The vast majority of 3D models created through modeling software or 3D scanning, and those available in online marketplaces, are defined by a polygonal mesh representation. Despite the advantages of polygonal meshes with respect to how 3D models are rendered by most graphics cards—as a set of triangles—polygonal mesh representations present a number of shortcomings.

For example, it is difficult to significantly reduce the polygon count (which reduces computational load) while preserving visual quality in order to generate representations with lower levels of detail that are necessary to optimize rendering performance. It is also difficult to non-destructively edit a polygonal mesh in an intuitive way that does not involve editing at the vertex level. Furthermore, it is difficult to compose, intersect, and fuse polygonal meshes without performing complex operations at the vertex level.

Implementations described herein make it feasible to convert polygonal meshes into geometric representations made of a set of primitives. Advantageously, these implementations allow users easier editing, provide users a straightforward method to create different levels of detail (LODs), and enable users to achieve higher efficiency at runtime in areas such as memory footprint and computational demand of physics calculations. The conversions may include the use of generative artificial intelligence (gen AI), e.g., in the form of a neural network or other machine learning model, as well as representations of Boolean operations that facilitate optimizing binary trees that define CSG models.

In particular, implementations present a unified differentiable Boolean operator for implicit solid shape modeling using Constructive Solid Geometry (CSG). Traditional CSG relies on min and max operators to perform Boolean operations on implicit shapes. However, because these Boolean operators are discontinuous and discrete in the choice of operation, this makes optimization over the CSG representation challenging.

Various implementations present a unified Boolean operator that outputs a continuous function and is differentiable with respect to operator types. This enables optimization of both the primitives and the Boolean operations employed in CSG with continuous optimization techniques, such as gradient descent. Implementations further demonstrate that such a continuous Boolean operator permits the modeling of both sharp objects (e.g., mechanical objects that are manmade, that have sharp lines, etc.) and smooth organic shapes (e.g., natural shapes, or manmade shapes that have smooth curves) with the same framework. The unified Boolean operator opens up new possibilities for future research toward fully continuous CSG optimization.

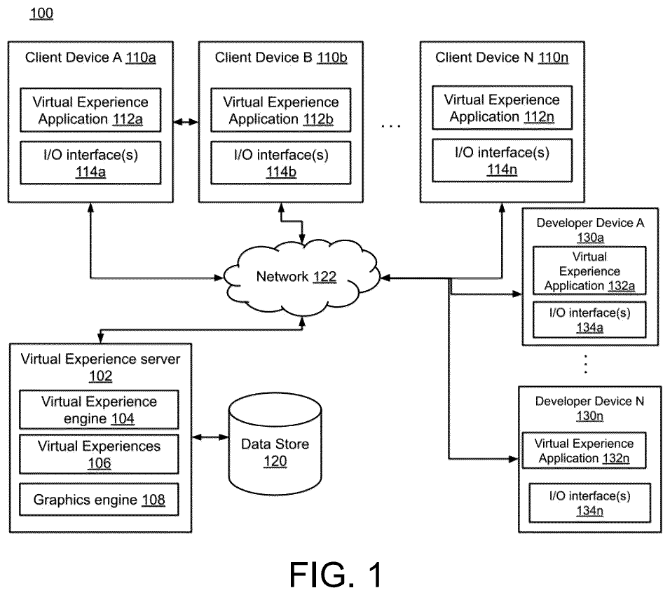

### FIG. 1: System Architecture

FIG. 1 is a diagram of an example system architecture in which solid shape modeling using constructive solid geometry (CSG) is performed, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

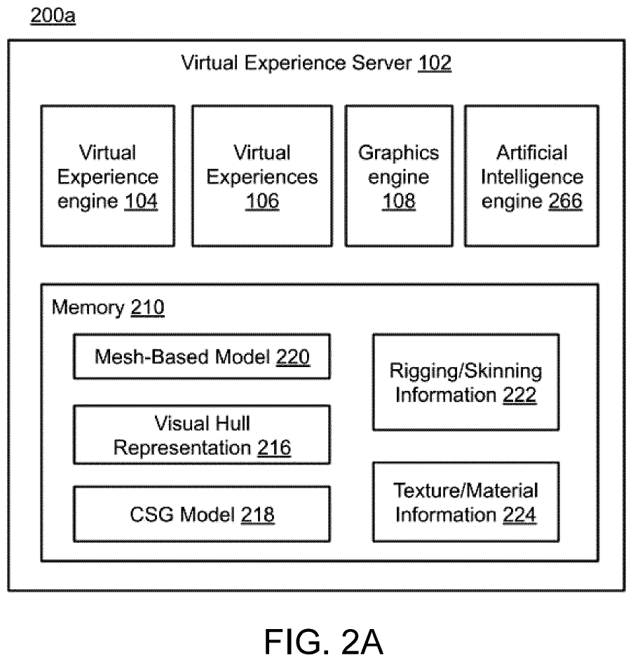

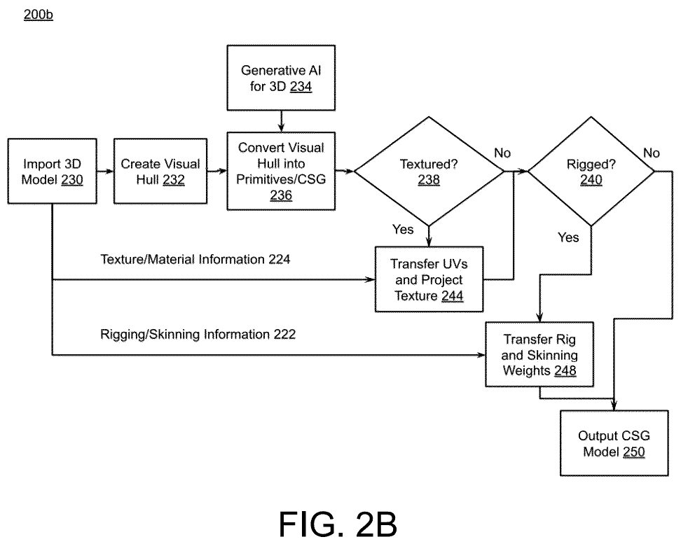

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or virtual experience engine 104 may perform one or more of the operations described below in connection with the flowcharts shown in FIGS. 2B, 3A, 3D, 4A-4B, and 9-10. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, gameplay session data are generated via online virtual experience server 102, virtual experience application 112, and/or virtual experience application 132, and are stored in data store 120. With permission from game players, gameplay session data may include associated metadata, e.g., game identifier(s); device data associated with the players; demographic information of the player(s); gameplay session identifier(s); chat transcripts; session start time, session end time, and session duration for each player; relative locations of participant avatar(s) within a virtual game environment; in-game purchase(s) by one or more player(s); accessories utilized by game players; etc. Virtual experience server 102 may store other types of information in data store 120.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between players, with appropriate permissions from the players and in compliance with applicable regulations.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual game environment, accessories utilized by game participants, etc. In some implementations, the chat transcripts may include multilingual content, and messages in different languages from different gameplay sessions of a game may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual experiences server. For example, the virtual experiences server may provide single-player or multiplayer games to a community of users that may access or interact with games using client devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to the interaction of one or more players using client devices (e.g., 110) within a virtual experience (e.g., virtual experience 106) or the presentation of the interaction on a display or other output device (e.g., 114) of a client device 110.

In some implementations, a virtual experience 106 can include an electronic file that can be executed or loaded using software, firmware or hardware configured to present the game content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different games may have different rules or goals from one another.

In some implementations, games may have one or more environments (also referred to as “gaming environments” or “virtual environments” herein) where multiple environments may be linked. An example of an environment may be a three-dimensional (3D) environment. The one or more environments of a virtual experience 106 may be collectively referred to as a “world” or “gaming world” or “virtual world” or “universe” herein. An example of a world may be a 3D world of a virtual experience 106. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “game objects” or “virtual game item(s)” herein) of virtual experiences 106.

For example, in generating user-generated virtual items, users may create characters, decoration for the characters, one or more virtual environments for an interactive game, or build structures used in a virtual experience 106, among others. In some implementations, users may buy, sell, or trade game virtual game objects, such as in-platform currency (e.g., virtual currency), with other users of the online virtual experience server 102. In some implementations, online virtual experience server 102 may transmit game content to virtual experience applications (e.g., 112). In some implementations, game content (also referred to as “content” herein) may refer to any data or software instructions (e.g., game objects, game, user information, video, images, commands, media item, etc.) associated with online virtual experience server 102 or virtual experience applications. In some implementations, game objects (e.g., also referred to as “item(s)” or “objects” or “virtual objects” or “virtual game item(s)” herein) may refer to objects that are used, created, shared or otherwise depicted in virtual experience 106 of the online virtual experience server 102 or virtual experience applications 112 of the client devices 110. For example, game objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the game platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private game), or made widely available to users with access to the online virtual experience server 102 (e.g., a public game). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the game (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two game objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on gameplay conditions. For example, if the number of users participating in gameplay of a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send gameplay instructions (e.g., position and velocity information of the characters participating in the group gameplay or commands, such as rendering commands, collision commands, etc.) to the client devices 110 based on control instructions. For instance, the online virtual experience server 102 may perform one or more logical operations (e.g., using virtual experience engine 104) on the control instructions to generate gameplay instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the gameplay instructions and render the gameplay for presentation on the displays of client devices 110.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates gameplay instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that enable a client device 110 to render gameplay of a game, such as a multiplayer game. The gameplay instructions may include one or more of user input (e.g., control instructions), character position and velocity information, or commands (e.g., physics commands, rendering commands, collision commands, etc.).

In some implementations, characters (or game objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g. shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g. shirts, pants, etc. the online gaming platform may provide users access to simplified 3D virtual object models that are represented by a mesh of a low polygon count, e.g. between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that in some implementations, a character may not include a character game object (e.g., body parts, etc.) but the user may control the character (without the character game object) to facilitate the user's interaction with the game (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other game objects, virtual experiences 106, or game environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and game catalog that may be presented to users. In some implementations, the game catalog includes images of games stored on the online virtual experience server 102. In addition, a user may select a character (e.g., a character created by the user or other user) from the character catalog to participate in the chosen game. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application may be an online virtual experiences server application for users to build, create, edit, upload content to the online virtual experience server 102 as well as interact with online virtual experience server 102 (e.g., play virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application 132 may be an online virtual experiences server application for users to build, create, edit, upload content to the online virtual experience server 102 as well as interact with online virtual experience server 102 (e.g., provide and/or play virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a game developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a game developer may obtain access to game virtual game objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

### FIG. 2A: Virtual Experience Server

FIG. 2A illustrates components 200a of a virtual experience server, in accordance with some implementations. Virtual experience server 102 includes virtual experience engine 104, virtual experiences 106, and graphics engine 108, which are also illustrated in FIG. 1. Virtual experience server 102 also includes artificial intelligence (AI) engine 266 and a memory 210. Memory 210 stores a visual hull representation 216, a constructive solid geometry (CSG) model 218, a mesh-based model 220, rigging/skinning information 222, and texture/material information 224.

In some implementations, graphics engine 108 is adapted to generate a visual hull representation of an object based on a mesh. A visual hull representation is a three-dimensional (3D) representation of the geometry of an object obtained from two-dimensional (2D) images of the object (such as by using virtual cameras situated at a variety of locations). In some implementations, different components of virtual experience server 102 (or of other devices) may generate a visual hull representation.

Certain techniques to generate a visual hull representation are known. For example, the volume carving and/or shape-from-silhouette methods may be used. Volume carving takes silhouettes of an object from many different viewpoints and projects these silhouettes onto one another to determine 3D geometries. Shape-From-Silhouette (SFS) is a shape reconstruction technique which constructs a 3D shape estimate of an object using silhouette images of the object. The output of a SFS technique is known as the Visual Hull (VH). These or any other suitable technique to obtain a visual hull representation may be used.

In some implementations, a CSG model is generated by artificial intelligence (AI) engine 266 based on a determined visual hull representation. In some implementations, artificial intelligence engine 266 includes a machine-learning model trained using a dataset of geometric primitives constructed together to form constructive solid geometry (CSG) models.

In some implementations, AI engine 266 may be an inference engine implemented using a neural network. In some implementations, the machine-learning model may be trained using any suitable technique, e.g., supervised learning, unsupervised learning, reinforcement learning, etc. In some implementations, the CSG model is initially generated by an AI engine and subsequently fits to the visual hull using an optimization process that optimizes a binary tree to fit the visual hull. In other implementations, the fitting is entirely handled by an optimization process. In some implementations, the CSG model is defined using continuous parameters, allowing the use of gradient descent techniques in the optimization.

In some implementations, parameters of the AI engine 266 (machine-learning model) are adjusted based on the training such that inferences (e.g., CSG model) are generated by AI engine 266 from input data (e.g., mesh-based model and/or visual hull).

In some implementations, artificial intelligence engine 266 is trained using a construction tree that includes non-destructive operations between the various primitives as well as the positions, rotations, and scales in 3D space of the various primitives. Such training data advantageously enables training the AI engine 266 such that elaborate 3D models may be inferred from primitives. In some implementations, versioning information for 3D models in the training data (e.g., that correspond to different levels of model complexity and/or updates to the model over time) is included in the training set.

Once a CSG model is created, the CSG model may be optimized by artificial intelligence engine 266 for runtime performance. For example, the primitive solid objects may be sampled to convert them into a representation having a selected polygonal count, keeping the UV map consistent. The CSG model is also easily editable in that a non-destructive tree is available and can be modified in an intuitive way and without affecting the validity of the entire model.

According to some implementations, the artificial intelligence engine 266 may work with parts of a CSG model. The parts may be put together without Boolean operations or may be added together with Boolean operations to make more complex 3D models. These complex 3D models include primitives and the Boolean operations govern how the primitives are combined.

For example, a CSG model may be defined by a binary tree, where the nodes of the binary tree specify Boolean operations and the leaves of the binary correspond to primitives. In some implementations, the primitives may be primitives of the same family, such as spheres, planes, quadrics, and tiny multilayer perceptrons (MLPs), which may be an example of tiny neural implicit networks. In some other implementations, primitives of different families may be present in a given binary tree.

In a subtraction example, a Boolean difference operation may be performed to remove the lower part of a model. In another example, several parts may be added together in Boolean add (or union) operations to obtain the groundtruth model (e.g., the model without the lower part). The evolution over time of the CSG model may be tracked by the neural network. Training may provide the neural network with the ability to build things (such as a CSG model).

In the illustrative implementation of FIG. 2A, artificial intelligence engine 266 may be executed any number of times to obtain an initial CSG model from a mesh-based model. This initial generation may occur prior to or during a virtual experience (e.g., a video game) played by a user on a client device 110. For example, conversion from a mesh-based model to a CSG model may be performed in order to render a user's avatar, character, or another object in a game.

Memory 210 is adapted to store data. Virtual experience server 102 stores data in memory 210. For example, the information stored in memory 210 may include the visual hull representation 216, the CSG model 218, and the mesh-based model 220. In some implementations, the mesh-based model 220 is transformed into a visual hull representation 216.

The visual hull representation 216 may be used as the basis of the CSG model 218. Memory 210 may also store rigging/skinning information 222 and texture/material information 224. Such information may supplement the CSG model 218 by providing additional information about properties of the appearance, internal structure, and movement corresponding to a CSG model 218.

### FIG. 2B: Information Processing Structure

FIG. 2B illustrates a flowchart of an example method 200b to generate a constructive solid geometry (CSG) model from a 3D model, in accordance with some implementations. In block 230, the information processing in FIG. 2B begins by importing a three-dimensional (3D) model. Such a 3D model may include at least one mesh. Such mesh(es) may include polygonal meshes (polygon meshes).

In 3D computer graphics and solid modeling, a polygon mesh is a collection of vertices, edges, and faces that define the shape of a polyhedral object. Such a polyhedral object may be a 3D object having a plurality of faces defined as polygons. Such faces usually consist of triangles (forming a triangle mesh), quadrilaterals (quads), or other simple convex polygons (n-gons), simplifying rendering. However, a mesh could include concave polygons, or even polygons with holes. Block 230 may be followed by block 232.

In block 232, these mesh(es) are used to create a visual hull. For example, the mesh(es) may be processed by using virtual cameras. The virtual cameras capture silhouettes of the object from a plurality of different viewpoints. Such silhouettes are processed using volume carving and/or shape-from-silhouette techniques to approximate the object itself. Such an approximation of the object is referred to as a visual hull of the object. The visual hull of the object is a closed water-tight manifold mesh. In some implementations, the visual hull represents the outermost surface of the object. Block 232 may be followed by block 236.

In block 236, the visual hull may be converted into primitives and CSG operations at block 236. For example, in block 234, generative AI may be used in such a conversion process. In some implementations, the generative AI may generate the CSG model based on the visual hull. In some implementations, the generative AI may provide an initial CSG model based on the visual hull for subsequent optimization.

In some implementations, the initial CSG model from the generative AI is optimized using an optimization technique, such as an optimization technique that converges on (outputs) a binary tree that defines a match of at least a threshold quality to the visual hull. In some implementations, the initial binary tree is generated randomly (rather than based on generative AI) and is optimized using an optimization technique. In some implementations, the CSG model is defined using a binary tree whose nodes are Boolean operations and whose leaves are primitives.

In some implementations, the Boolean operations may be defined using continuous Boolean operators and, in some implementations, the primitives may be defined using continuous parameters for a primitive family. An advantage of using continuous parameters is that it makes it feasible to optimize the parameters of the tree in a way that takes advantage of continuous values, such as gradient descent techniques (that involve differentiable functions).

In addition to the information about the visual hull, the 3D model may include texture/material information 224, and rigging/skinning information 222. After the initial CSG model is created at block 236 (using generative AI and/or optimization techniques), at block 238 it is verified if the model is to be textured. If the model is not to be textured, block 240 follows block 238.

If the model is to be textured, at block 244 texture/material information 224 is transferred as UVs and the texture is projected appropriately such as by using UV mapping. UV mapping is a 3D modeling technique for projecting a 3D model's surface to a 2D image for texture mapping.

The letters “U” and “V” denote the axes of the 2D image while the letters “X,” “Y,” and “Z” denote the axes in 3D model space and the letter “W” is used for other applications. The UV mapping process involves assigning pixels in the image to surface mappings on the polygon, usually done by “programmatically” copying a triangular piece of the image map and pasting the piece of the image map onto a triangle on the object.

After block 238 (and block 244, if applicable), the method continues at block 240. At block 240, it is verified if the model is rigged. Rigging involves creating a skeleton or a system of joints and controllers that allow successful animation of a model. Rigging weights may help define how much influence each portion of the skeleton has on the mesh when the portion of the skeleton is moved or animated. Skinning involves attaching the model's surface or mesh to the rig, so that the model's surface or mesh deforms properly when the rig moves. The weights define how skinning occurs. If the model is rigged, rig and skinning weights are transferred at block 248. If the model is not rigged, block 240 is followed by block 250.

After block 240 (and block 248, if appropriate), the method continues at block 250. At block 250, the CSG model may be output. Such a CSG model is a converted representation from the initial visual hull generated from the mesh(es). As noted, in some implementations, the CSG model is defined as a binary tree.

The CSG model may match or almost match the visual hull. The match of the CSG is achieved by using generative AI techniques and/or optimization techniques (such as continuous optimization techniques for the Boolean operators and the primitive parameters). The CSG model at block 250 may also be associated, as appropriate, with texture/material information 224 and/or rigging/skinning information 222.

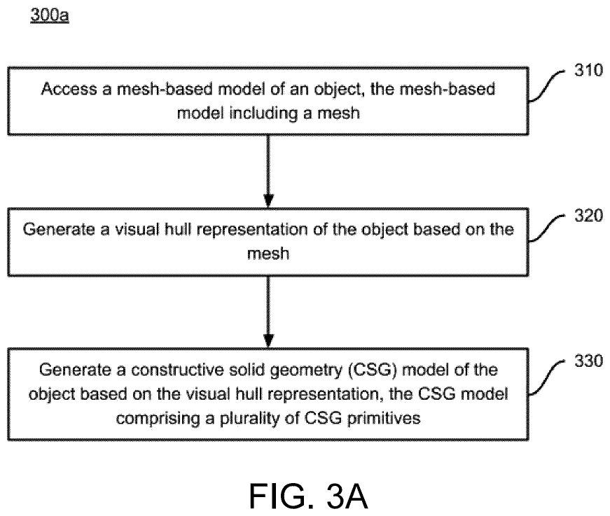

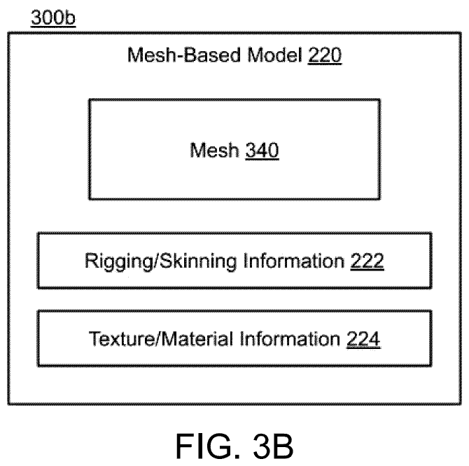

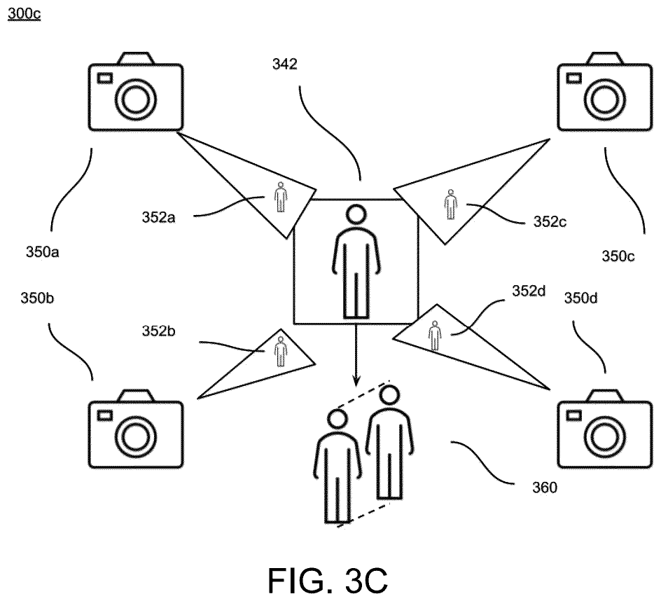

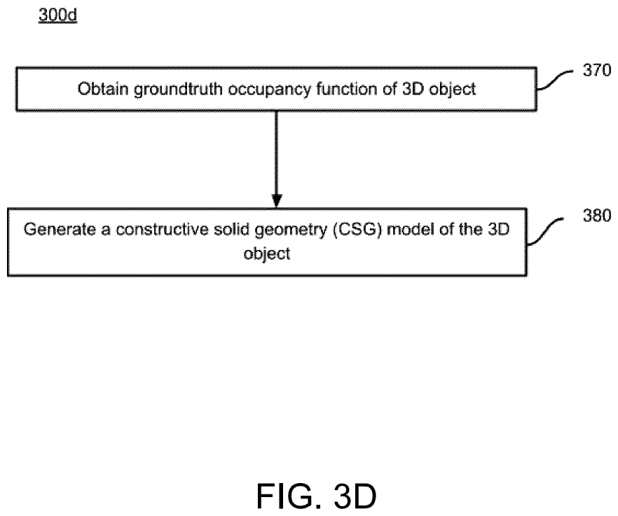

FIG. 3A: Generating a CSG Model from Mesh-Based Model

FIG. 3A illustrates an example method 300a of generating a constructive solid geometry (CSG) model, in accordance with some implementations. In various implementations, the steps illustrated in FIG. 3A and described below may be performed by any of the elements illustrated in FIG. 1 and/or in FIG. 2A. For example, in one implementation, one or more of the steps illustrated in FIG. 3A may be performed by a client device 110. In other implementations, one or more of the steps illustrated in FIG. 2 may be performed by virtual experience server 102. In another implementation, one or more of the steps illustrated in FIG. 3A may be performed by a developer device 130. Method 300 may begin at block 310.

In accordance with some implementations, a model of an object including a mesh (or multiple meshes) is converted into a model of the object that is built using CSG primitives. A model of an object that includes at least one mesh is referred to herein as a “mesh-based model.”

At block 310, a mesh-based model of an object is accessed. The mesh-based model includes at least one mesh. Such a mesh is a model (which may be a polygonal mesh) that defines a three-dimensional surface for the object, such as by using a collection of vertices, edges, and faces. Thus, the mesh(es) included in the mesh-based model may include sufficient information to specify the vertices, edges, and faces in a given mesh. This information may take a variety of forms.

In some implementations, the meshes may be defined by reference points in three dimensions (having X, Y, and Z coordinates). These reference points are connected by edges that cause the points and edges to define faces that cause the mesh to define a surface for a three-dimensional object. Thus, a given mesh is a collection of two or more vertices and edges between different pairs of vertices. The vertices are arranged in 3D space (each vertex has a 3D coordinate).

For example, virtual experience server 102 may receive a mesh-based model or may retrieve a mesh-based model from storage. In an implementation, virtual experience server 102 may import a mesh-based model of an object from storage. Referring to FIG. 1, virtual experience server 102 may access data store 120 to retrieve the mesh-based model. Alternatively, virtual experience server 102 may receive a mesh-based model from a client device 110, from a developer device 130, or from another source via network 122.

In the example implementation of FIG. 3A, virtual experience server 102 stores the mesh-based model in memory 210 as mesh-based model 220. As noted, mesh-based model 220 may include a single mesh corresponding to the object or may include multiple meshes corresponding to the object (such as different portions of the object, which may be considered in combination). Block 310 may be followed by block 320, where a visual hull representation is generated, which may be followed by block 330, where a CSG model is generated. Block 320 and block 330 are discussed further herein with reference to the discussion of FIG. 3B.

### FIG. 3B: Structure of Mesh-Based Model

FIG. 3B illustrates components 300b of mesh-based model 220 in accordance with an implementation. In some implementations, mesh-based model 220 includes a mesh 340, rigging/skinning information 222, and texture/material information 224. As noted, mesh-based model 220 includes at least one mesh 340.

Mesh 340 specifies a set of vertices, edges, and faces that define the shape and structure of a 3D object. In some implementations, mesh 340 is a polygonal mesh and contains a plurality of vertices, edges and faces that define the shape of the object. The faces may have triangular shapes or other shapes. In other implementations, other types of meshes may be used. In some implementations, a mesh-based model may include more than one mesh.

Rigging/skinning information 222 defines a skeletal structure or armature for the object. Rigging/skinning information 222 also includes joint weighting information that assigns each vertex of the mesh to one or more joints of the skeleton and defines a weight value for each joint. By assigning weights to vertices, the mesh deforms smoothly as the underlying skeleton moves, resulting in realistic animations.

Thus, the rigging/skinning information 222 may include information defining a joint hierarchy, joint positions, joint orientations, joint weights for each vertex, and any additional constraints or animations applied to the rig. The rigging/skinning information may include additional information such as bind pose information and animation data.

Texture/material information 224 defines information about the surface of the object. Such information includes material properties such as color, texture coordinates, normals, and more. Texture coordinates help map textures onto the mesh, giving the mesh a realistic appearance. Normals define the direction each face is facing, enabling proper shading and lighting calculations.

Texture/material information 224 may include one or more of the following types of information: diffuse texture data which defines the base color or appearance of the surface, specular texture data which defines the shininess or reflectivity of the surface, a normal map which is used to add high-frequency details to a surface without modifying the geometry, a roughness/glossiness map which determines the surface roughness or glossiness of the object, an ambient occlusion map which simulates the darkening effect caused by ambient light occlusion in crevices or areas where objects come into contact, etc.

In some implementations, after the mesh-based model 220 has been imported or otherwise accessed, rigging/skinning information 222 and texture/material information 224 may be extracted from the mesh-based model and stored separately. In the illustrative implementation of FIG. 2A, virtual experience server 102 extracts rigging/skinning information 222 and texture/material information 224 and stores the information in memory 210 as rigging/skinning information 222 and texture/material information 224, respectively.

Returning to FIG. 3A, at block 320, a visual hull representation of the object is generated based on the mesh. In accordance with one implementation, a visual hull method is used in which a series of virtual cameras calculate the silhouette of the 3D object. Then, through volume carving and/or shape-from-silhouette techniques, implementations create an approximate representation of the object itself that is a closed watertight manifold mesh and has advantageous mathematical properties. In other implementations, other techniques may be used to generate a visual hull representation of the object based on the mesh.

In the illustrative implementation of FIG. 2A, virtual experience server 102 generates a visual hull representation based on mesh 340 of mesh-based model 220. Virtual experience server 102 stores the visual hull representation in memory 210 as visual hull representation 216. Block 320 may be followed by block 330.

At block 330, a constructive solid geometry (CSG) model of the object is generated based on the visual hull representation, wherein the CSG model includes a plurality of CSG primitives. In the illustrative implementation, virtual experience server 102 generates a CSG model based on visual hull representation 216.

Virtual experience server 102 may generate a CSG model using any suitable technique. In some implementations, virtual experience server 102 causes artificial intelligence engine 266 to generate the CSG model. Accordingly, artificial intelligence engine 266 generates a set of primitives and CSGs that best matches the geometry of visual hull representation 216. Such results of an artificial intelligence engine 266 may be used to generate the CSG model or may be used to provide an initial version of the CSG model for later optimization. Referring to FIG. 2A, virtual experience server 102 stores the CSG model in memory 210 as CSG model 218.

In accordance with some implementations, rigging/skinning information and/or texture/material information may be extracted from the mesh-based model and stored separately in memory while the visual hull representation is generated and the CSG model is generated based on the visual hull representation. Both the rigging/skinning information and the texture/material information (if available) are then retrieved from memory and transferred to the CSG model.

### FIG. 3C: Example of Generating Visual Mesh

FIG. 3C illustrates the use of a mesh-based model(s) as the basis of a visual hull 300c, in accordance with some implementations. FIG. 3C illustrates an example of obtaining meshes from a variety of angles to gather information to assemble a visual hull, in accordance with some implementations. FIG. 3C illustrates a mesh of an object 342, such as a person.

The object 342 may be photographed from different angles, such as by virtual camera 350a, virtual camera 350b, virtual camera 350c, and virtual camera 350d. For example, virtual camera 350a may capture silhouette 352a, virtual camera 350b may capture silhouette 352b, virtual camera 350c may capture silhouette 352c, and virtual camera 350d may capture silhouette 352d. These silhouettes, when combined, allow for the calculation of a 3D visual hull representation 360 of the object 342.

Based on the silhouettes, acquired through volume carving or shape-from-silhouette (or another appropriate visual hull generation technique), the visual hull generation may create an approximate representation of the object itself 230 that is a closed watertight manifold mesh and has great mathematical properties. FIG. 3C illustrates that silhouette 352a, silhouette 352b, silhouette 352c, and silhouette 352d are combined into a three-dimensional (3D) visual hull representation 360.

Because the visual hull representation 360 is a manifold, the visual hull representation 360 is watertight and includes no holes or missing faces that may cause leaks into the shape's volume. For a mesh to be manifold, every edge is to have exactly two adjacent faces.

### FIG. 3D: Generating a CSG Model

FIG. 3D illustrates an example method 300d to generate a constructive solid geometry (CSG) model, in accordance with some implementations. Method 300d may begin at block 370.

At block 370, a groundtruth occupancy function of a 3D object is obtained. Such a groundtruth occupancy function specifies the nature of the 3D object that the CSG model is to correspond to. An occupancy function is ordinarily a two-valued function in a universe of points that takes a point (such as a point in space) and maps the point to a value of 0 if the point does not lie within a shape and maps the point to a value of 1 if the point lies within a shape. However, in some implementations a soft occupancy function may be used representing the probability lying inside the shape, mapping the point to a probability value in the interval [0,1]. Block 370 may be followed by block 380.

At block 380, a constructive solid geometry (CSG) model of the 3D object is constructed. The CSG model may be defined by a binary tree wherein nodes of the binary tree define Boolean operations and leaves of the binary tree define parameters of CSG primitives.

Values of the Boolean operations and values of the parameters of the CSG primitives for the binary tree are identified by minimizing an error between an occupancy function of the CSG model and the groundtruth occupancy function of the 3D object. For example, the binary tree may be initialized with random parameter values. Minimizing the error may include iteratively modifying the values of the Boolean operations and the values of the parameters of the CSG primitives in the binary tree to minimize the error between the occupancy function of the CSG model and the groundtruth occupancy function of the 3D object. The Boolean operations may correspond to unified fuzzy Boolean operators that are differentiable with respect to a type of Boolean operator. Additional aspects of such unified fuzzy Boolean operators are discussed herein.

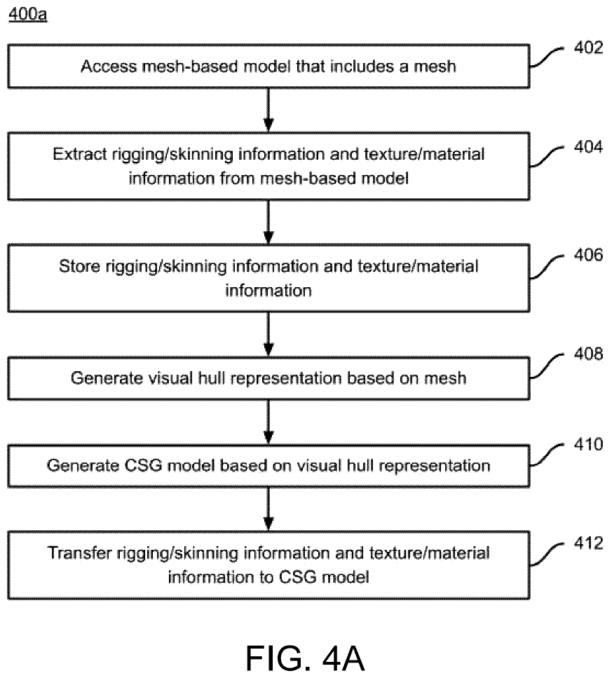

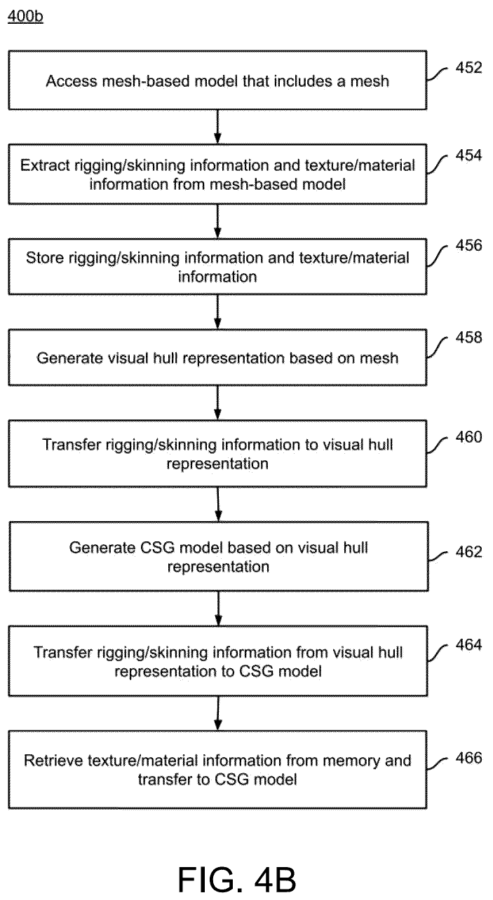

### FIG. 4A: Converting Mesh-Based Model to CSG Model

FIG. 4A illustrates a method 400a to convert a mesh-based model to a constructive solid geometry (CSG) model with some implementations. Method 400a may begin at block 402.

At block 402, a mesh-based model including a mesh is accessed. In the manner discussed above, virtual experience server 102 retrieves or otherwise accesses a mesh-based model 220 and stores the model in memory as mesh-based model 220. Block 402 may be followed by block 404.

At block 404, rigging/skinning information and texture/material information are extracted from the mesh-based model. In the illustrative implementation, virtual experience server 102 accesses mesh-based model 220 and extracts rigging/skinning information 222 and texture/material information 224 from the mesh-based model 220. Block 404 may be followed by block 406.

At block 406, the rigging/skinning information and texture/material information are stored in a memory. Referring to the example of FIG. 2A, virtual experience server 102 stores rigging/skinning information 222 and texture/material information 224 in memory 210.

Rigging/skinning information may be stored in any suitable format. In various implementations, rigging/skinning information may be stored using file formats such as FBX (Filmbox), COLLADA (DAE), or Alembic (ABC). In some implementations, rigging/skinning information may be stored using a proprietary file format, a generic file format, or any other appropriate file format not explicitly listed. Rigging/skinning information may be stored in a different manner.

Texture and material information may be stored in any suitable manner. In some implementations, texture information is stored as 2D texture maps containing pixel data that represent the appearance of the surface, such as color, roughness, reflectivity, and other material properties. Material information may be stored as parameters that define various material properties. Texture and material information may be stored in the same manner or in a different manner. Block 406 may be followed by block 408.

At block 408, a visual hull representation is generated based on the mesh. As discussed in the explanation of some implementations, virtual experience server 102 may use a visual hull method (such as volume carving and/or shape from silhouette) to generate a visual hull representation based on mesh 340 from mesh-based model 220. The visual hull representation is stored in memory 210 as visual hull representation 216 as illustrated in FIG. 2A. Block 408 may be followed by block 410.

At block 410, a CSG model is generated based on the visual hull representation. Virtual experience server 102 generates a CSG model based on visual hull representation 216. In some implementations, artificial intelligence engine 266 generates a CSG model based on visual hull representation 216. The output of artificial intelligence engine 266 may be used as the generated CSG model without further changes or may be provided as an initial state for an optimization technique.

The CSG model may be caused to match visual hull representation 216 by using an optimization technique. The optimization technique may begin with an initially generated CSG model from artificial intelligence engine 266 or may begin with a CSG model with arbitrary (random) parameters. Such a model is optimized to cause the final generated CSG model to match the visual hull representation 216 as closely as is feasible. The final CSG model (whether from the artificial intelligence engine 266 or from an optimization technique) is stored in memory 210 as CSG model 218. Block 410 may be followed by block 412.

At block 412, the rigging/skinning information and texture/material information is transferred to the CSG model. Virtual experience server 102 retrieves rigging/skinning information 222 and texture/material information 224 from memory 210 and transfers rigging/skinning information 222 and texture/material information 224 to CSG model 218.

It may be advantageous to transfer the rigging/skinning information (but not the texture/material information) from the mesh-based model to the visual hull representation and then transfer the texture/material information from the visual hull representation to the CSG model.

Accordingly, in another implementation, a model including a mesh is accessed, and skinning/rigging information and texture/material information are extracted from the mesh and stored in a memory. A visual hull representation is generated based on the mesh. The rigging/skinning information is transferred to the visual hull representation.

A CSG model is generated based on the visual hull representation. The rigging/skinning information is transferred from the visual hull representation to the CSG model. The texture/material information is then retrieved from memory and transferred to the CSG model. Hence, the CSG is a good representation of the shape of the visual hull representation. Once this is achieved, it may be possible to use texture/material information to help change the appearance of the shape by controlling what is illustrated on surfaces of the shape.

### FIG. 4B: Converting Mesh-Based Model to CSG Model

FIG. 4B illustrates another example method 400b to convert a mesh-based model to a constructive solid geometry (CSG) model, in accordance with some implementations. Method 400b may begin at block 452.

At block 452, a mesh-based model that includes a mesh is accessed. In the illustrative implementation of FIG. 2, virtual experience server 102 accesses mesh-based model 220. Block 452 is similar to block 402. Block 452 may be followed by block 454.

At block 454, rigging/skinning information and texture/material information are extracted from the mesh-based model. Virtual experience server 102 extracts rigging/skinning information 222 and texture/material information 224 from mesh-based model 220. Block 454 is similar to block 404. Block 454 may be followed by block 456.

At block 456, the rigging/skinning information and the texture/material information are stored in memory. Virtual experience server 102 stores rigging/skinning information 222 and texture/material information 224 in memory 210. Block 456 is similar to block 406. Block 456 may be followed by block 458.

At block 458, a visual hull representation is generated based on the mesh. Virtual experience server 102 generates visual hull representation 216 based on mesh 340 of mesh-based model 220. Visual hull representation is stored in memory 210 as visual hull representation 216. Block 458 is similar to block 408. Block 458 may be followed by block 460.

At block 460, the rigging/skinning information is transferred to the visual hull representation. Virtual experience server 102 transfers rigging/skinning information 222 to visual hull representation 216. By transferring this information to the visual hull representation, it may be feasible to include the rigging/skinning information as a part of the generation of the CSG model at block 462. Block 460 may be followed by block 462.

At block 462, a CSG model is generated based on the visual hull representation. Virtual experience server 102 generates a CSG model based on the visual hull representation 216. In some implementations, artificial intelligence engine 266 generates a CSG model based on visual hull representation 216. Also, the CSG model may be generated using optimization techniques to match a tree to the visual hull representation 216. The CSG model is stored in memory 210 as CSG model 218. Block 462 is similar to block 410. Block 462 may be followed by block 464.

At block 464, rigging/skinning information is transferred from the visual hull representation to the CSG model. Virtual experience server 102 transfers the rigging/skinning information from visual hull representation 216 to CSG model 218. Block 464 may be followed by block 466.

At block 466, texture/material information is retrieved from memory and transferred to the CSG model. Virtual experience server 102 retrieves texture/material information 224 from memory 210 and transfers the texture/material information to CSG model 218. For example, at block 466, the shaping of CSG model 218 is complete and texture/material information 224 may be mapped onto the surface of CSG model 218.

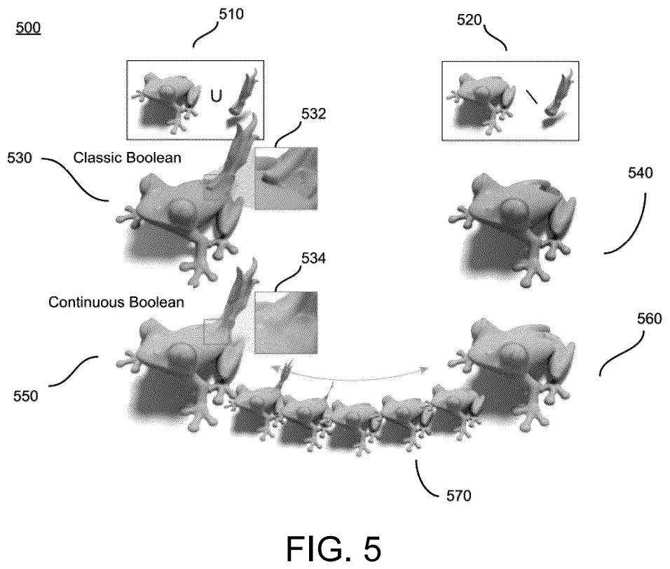

### FIG. 5: Traditional and Continuous Boolean Operations for CSG Models

FIG. 5 illustrates constructive solid geometry (CSG) models based on classic Boolean operations and CSG models based on continuous Boolean operations 500, in accordance with some implementations.

As discussed herein, Boolean operations are a central ingredient in Constructive Solid Geometry (CSG). CSG is a modeling paradigm that represents a complex shape using a collection of primitive shapes that are combined together using Boolean operations (e.g., intersection, union, and difference). CSG provides a precise, hierarchical representation of solid shapes and is widely used in computer graphics. The importance of CSG has motivated researchers to investigate the inverse problem, which includes constructing a binary tree for a given 3D model from a collection of parameterized primitive shapes.

A common approach is to treat this inverse problem as an optimization problem that involves choosing the structure of the binary tree. Such a structure includes the type of Boolean operation to perform at each internal node in the tree, as well as the parameters and type (e.g., sphere, cube, cylinder) of the leaf node primitive shapes.

The optimization may be difficult because the optimization may contain a mixture of discrete (type of Boolean operation, number and type of primitive shapes) and continuous (parameters of primitives e.g., radius, width, etc.) variables. Also, the degrees of freedom grow exponentially with the complexity of the binary tree, making the optimization landscape very challenging to navigate.

Other approaches either tackle the inverse optimization directly with evolutionary algorithms or relax some of the discrete variables into continuous variables to reduce the discrete search space. For instance, one of the discrete decisions is to determine which primitive types (e.g., sphere, cube, cylinder) to use, and a common relaxation is to optimize over a continuously parameterized family of primitives, such as quadric surfaces.

This approach permits continuous optimization (e.g., gradient descent) over choosing the type of each primitive, but not the entire tree. The choice of Boolean operations and the number of primitives remain discrete variables. Accordingly, these inverse CSG methods pre-determine the structure of the tree including both the Boolean operations and the number of primitives and focus on optimizing the primitive parameters. By contrast, implementations use a unified differentiable Boolean operator and illustrate how this type of operator may be used to further relax inverse CSG optimization by turning the discrete choice of Boolean operation for each internal CSG node into a continuous optimization variable.

Drawing inspiration from fuzzy logic, this disclosure specifies how individual fuzzy logic operations (e.g., t-norms, t-conorms) may be applied to Boolean operations on solid shapes represented as soft occupancy functions. Fuzzy Boolean operators guarantee that a result remains a soft occupancy function, unlike other Boolean operators (e.g., with min/max) that operate on signed distance functions. These fuzzy Booleans on the soft occupancy naturally generalize CSG from modeling shapes with sharp edges to modeling smooth organic shapes.

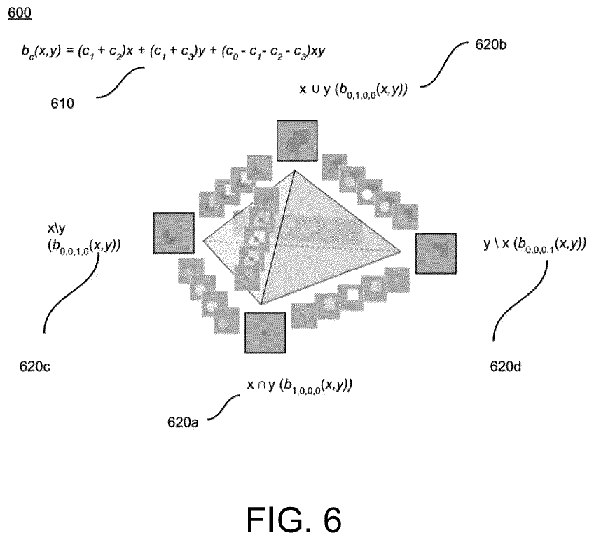

Implementations may construct a unified fuzzy Boolean operator that uses tetrahedral barycentric interpolation to combine the individual fuzzy Boolean operations (see FIG. 6). As discussed, the unified fuzzy Boolean operator is differentiable, avoids vanishing gradients, and is monotonic. These properties make the unified fuzzy Boolean operator especially well-suited for gradient-based optimization. Some implementations may apply the unified Boolean operator in the context of inverse CSG optimization and may thus find significant improvements in the accuracy of the resulting tree as compared to other methods.

Thus, the fuzzy Boolean operations can continuously back-propagate gradients to the subtrees. In addition, using fuzzy Booleans enables continuous optimization over different Boolean operations. As a side benefit, the fuzziness of these Boolean operators naturally generalizes CSG from modeling shapes with crisply sharp edges to organic smooth objects. By leveraging fuzzy logic, inverse CSG can be a differentiable process and may be solved with continuous optimization techniques. Using these approaches may benefit existing pipelines for binary tree generation.

To achieve these results, implementations may use a differentiable Boolean operator with respect to the operands and the Boolean operator. Given two implicit shapes, the Boolean operator can control the blend region between two shapes and output a smoothly differentiable function. Implementations can also continuously switch the operator from one to another, such as from a union to difference to an intersection.

FIG. 5 illustrates a union operation for a frog and a tail 510 (appending a tail to a frog) and a difference operation for a frog and a tail 520 (separating a tail from the frog). FIG. 5 also illustrates a classic Boolean result of such a union operation 530 and a classic Boolean result of such a difference operation 540. However, there may also be a continuous Boolean operation that smoothly transforms between a specific continuous union Boolean operation 550 and a specific continuous difference Boolean operation 560. Such a transition is illustrated at states 570. Additional aspects of such continuous Booleans are discussed further. For example, FIG. 5 shows a close-up of the frog's tail area using a classic Boolean 532 and a close-up of the frog's tail area using a continuous Boolean 534. There may be a smooth, natural surface of the tail fusing with the body in the continuous Boolean 534 as compared to an incorrect tail appearing as an appendage to the body of the frog in the top figure.

### FIG. 6: Unified Continuous Boolean Operation

FIG. 6 illustrates a visualization of a unified continuous Boolean operation 600, in accordance with some implementations.

To incorporate fuzzy logic in CSG modeling, implementations interpret a solid shape, represented by a soft occupancy function, as a fuzzy set X={P, ƒ_{X}}. Here, P={p} denotes the universe of points p∈ [symbol] ^{d} and the membership function ƒ_{X}: P→[0,1] is the soft occupancy function representing the probability of a point lying inside the shape. Then implementations can directly apply the fuzzy Boolean operations presented herein. However, implementations choose intersection, union, and complement appropriate to the task (i.e., CSG modeling). The following disclosure first presents a choice for each of these functions (i.e., intersection, union, and complement) and then describes how to combine these choices into a unified Boolean operator.

Motivated by the feature of continuous optimization, each of the individual fuzzy Boolean operations intersection T, union 1, and complement C may be differentiable and have non-vanishing (i.e. non-zero) gradients with respect to their inputs. Vanishing gradients may result in plateaus in the energy landscape, making gradient-based optimization difficult. Boolean operators as defined by the product fuzzy logic meet these criteria. Specifically, Boolean operators are defined as ƒ_{X∩Y}=T(x, y)=xy, ƒ_{X∪Y}=⊥(x, y)=x+y−xy, ƒ_{⊥X}=C(x)=1−x.

In these definitions, X and Y are two solid shapes and x=ƒ_{X(p)}, y=ƒ_{Y(p)}, ∈[0.1,] are their soft occupancy values at a generic point p. These definitions satisfy the axioms of valid Boolean operators (e.g., boundary condition, monotonicity, commutativity, associativity for intersection and union, boundary condition and monotonicity for complement). The definitions correspond to valid t-norm T, t-conorm ⊥, and complement C functions, respectively, in fuzzy logic. These definitions also satisfy De Morgan's Law, allowing computing differences as ƒ_{X\Y}=x−xy and ƒ_{Y\X}=y−xy.

The product fuzzy logic Boolean functions are differentiable with respect to their inputs x and y. Other fuzzy logic functions, such as Gödel's min/max, t-norm/t-conorm, etc., are not differentiable at singularities. In addition, the product fuzzy logic functions are also much less prone to vanishing gradients compared to many other fuzzy logic function definitions. More formally, vanishing gradients occur when the partial derivatives ∂/∂x, ∂/∂y equal zero (or become very small).

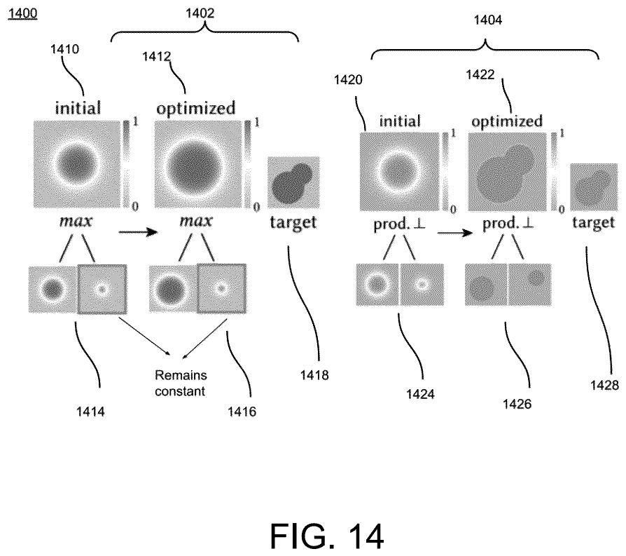

For example, there may be case where occupancy values x are strictly larger than or equal to y. Defining union with the Gödel's max operator results in a zero gradient for y, as ∂/∂y=0. In contrast, using the union defined above still possesses non-zero gradients for both x, y. In FIG. 14, the importance of avoiding vanishing gradient in a simple example of the inverse CSG task with continuous optimization is illustrated further.

To create a unified fuzzy Boolean operator that is differentiable with respect to the type of Boolean operation (e.g., intersection, union, difference), implementations interpolate their respective membership functions using a set of interpolation control parameters c. Implementations provide an interpolation scheme that is continuous and monotonic in the parameters c so that the interpolation function avoids unnecessary local minima.

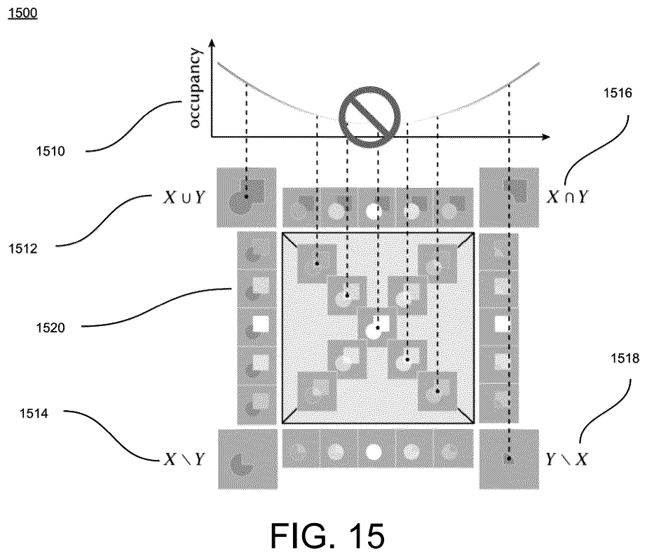

A naïve solution is to use bilinear interpolation between the four Boolean operations ƒX∩Y, ƒX∪Y, ƒX\Y, ƒY\X. While such interpolation can look smooth, bilinear interpolation exhibits non-monotonic changes and creates local minima in the interpolated occupancy (see FIG. 15). This is because bilinear interpolation implicitly forces the average between ƒX∪Y, ƒY\X and the average between ƒX∩Y, ƒX\Y to be equivalent. In many cases, these averages are not equivalent and thus the constraint forces the interpolation to be non-monotonic.

Instead of this, various implementations described herein use tetrahedral barycentric interpolation. More specifically, implementations treat individual Boolean operations (union, intersection, and two differences) as vertices of a tetrahedron and define the unified Boolean operator function B_{c} as barycentric interpolation within the tetrahedron as B_{c}(x, y)=(c₁+c₂) x+ (c₁+c₂₃)y+(c₀−c₁−c₂−c₃)xy (Equation 1) where c={c₀, c₁, c₂, c₃} are parameters that control the type of Boolean operations and they satisfy the properties of barycentric coordinates that 0≤c₁≤1 and c₀+c₁+c₂+c₃=1. Thus, the unified fuzzy Boolean operators are defined by a tetrahedral barycentric interpolation scheme, based on barycentric coordinates that specify a position between binary Boolean operations that define a tetrahedron.

When the parameter c is a one-hot vector, i.e. the barycentric coordinates for the vertices of a tetrahedron, the parameter c exactly reproduces the product logic operators. For example, B_{1,0,0,0}(x, y)=xy=ƒ_{X∩Y}, B_{0,1,0,0}(x, y)=x+y−xy=ƒ_{X∪Y}, B_{0,0,1,0}(x, y)=x−xy=ƒ_{X\Y}, B_{0,0,0,1}(x, y)=y−xy=ƒ_{Y\x}.

From the equation defining the unified operator, it is clear that the unified operator is continuously differentiable, with respect to both the inputs ∂B_{c}/∂x, ∂B_{c}/∂y and the control parameters ∂B_{c}/∂cᵢ by design. Moreover, the operator B_{c} provides monotonic interpolation between the individual Boolean operations at the vertices because interpolation along the edge of a tetrahedron is equivalent to a one-dimensional (1D) convex combination, as illustrated in FIG. 6. Empirically, using barycentric interpolation leads to a smaller error compared to using bilinear interpolation.

Compared to other choices of t-norms, such as the Yager t-norm/t-conorm, the formulation presented here avoids raising to the power of p and 1/p, thus having better numerical robustness. The unified Boolean operator also avoids the issue of vanishing gradient, meaning both ∂B_{c}/∂x, ∂B_{c}/∂y≠0. This property is useful in the case corresponding to implementations, because if the gradient vanishes with respect to a certain parameter, the parameter may be “dead” and fail to get updates to minimize the objective function. It may be relevant to avoid a vanishing gradient in an application of inverse CSG.

The next property is to ensure the interpolation between different Boolean operations avoids local minima for better optimization behavior. A naïve solution is to use bilinear interpolation to interpolate between four Boolean operations. While such interpolation may look smooth, bilinear interpolation exhibits non-monotonic changes and creates local minima in the interpolated occupancies because these four Boolean operations are not “coplanar” in the interpolated space.

In other words, the average between X∪Y, Y\X and the average X∩Y, X\Y may not have the same occupancy value. This observation leads to a treatment of the four Boolean operations (union, intersection, and two differences) as four vertices of a tetrahedron and using barycentric interpolation within to define the unified Boolean.

Because interpolation along the edge of a tetrahedron is equivalent to a one-dimensional (1D) convex combination, this leads to monotonic interpolation behavior between operations. Empirically, this barycentric interpolation leads to a smaller error compared to using bilinear interpolation (in the naïve case).

FIG. 6 illustrates a tetrahedron as discussed above. For example, FIG. 6 illustrates the definition of the unified Boolean operator B 610, as presented above. The unified Boolean operator B 610 is defined as a continuous fuzzy unified Boolean operator. FIG. 6 also illustrates the corners of the tetrahedron corresponding to the tetrahedral barycentric interpolation, including corner 620a, corner 620b, corner 620c, and corner 620d.

For example, corner 620a corresponds to an intersection operation. Corner 620b corresponds to a union operation. Corner 620c corresponds to a difference operation (X \ Y). For example, corner 620d corresponds to another difference operation (Y \X). Various other points in the tetrahedron, represented by barycentric coordinates, represent smooth transitions between operators, defining a unified and continuous Boolean operator.

Hence, FIG. 6 provides for using barycentric interpolation to provide monotonic interpolation between different Boolean operators. This avoids local minima in occupancy interpolation.

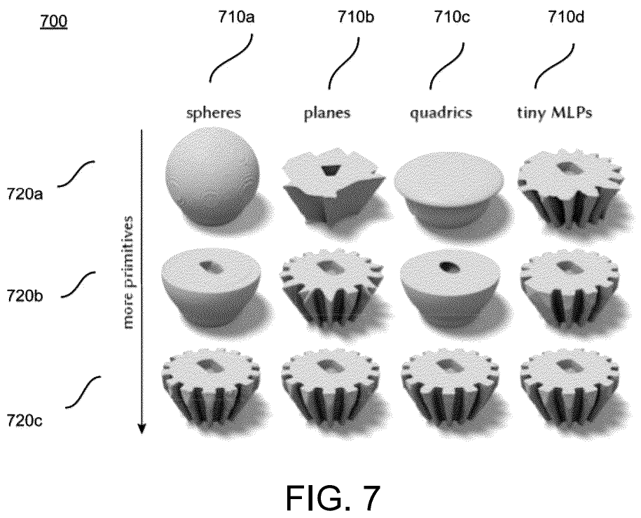

### FIG. 7: Fitting Shapes Using CSG and Gradient Descent

FIG. 7 illustrates several examples of fitting a shape with constructive solid geometry (CSG) via gradient descent and different primitives 700, in accordance with some implementations. For example, the groundtruth shape may be a conic section with a carved out central region and carved out regions around the edges.

The approaches presented herein enable one to simply use gradient descent (or a related optimization technique) to optimize a binary tree that outputs a given shape, even for smooth organic objects, such as illustrated in FIG. 7. The advantageous continuous approach may be independent with respect to the choice of primitive families.

In various implementations, it is feasible to convert an arbitrary shape (e.g., any virtual 3D object that is to be used within a virtual experience) into a CSG composed of primitives from a family, such as spheres 710a, planes 710b, quadrics 710c, or even tiny neural networks (such as tiny multilayer perceptrons 710d). Compared to an approach including fixing Boolean operations and only optimizing the primitive parameters, the techniques presented herein that allow for continuous optimization of Boolean operations leads to better reconstruction, such that the results are closer to a groundtruth volume than alternative optimization techniques such as Gödel logics or product logic.

Thus, the techniques described herein are applicable to different types of primitives, including spheres 710a, planes 710b, quadrics 710c, and tiny neural implicit networks (such as tiny multilayer perceptrons 710d). For example, the tiny multilayer perceptrons 710d may be fully connected neural networks that take input coordinates (3 scalars: x, y, z) and output a single scalar (which can be an arbitrary number). The MLPs may use a sigmoid function to map that arbitrary number to a soft occupancy function between 0 and 1.

Accordingly, the MLP may behave like an implicit function (like quadric surfaces, spheres, planes) which maps each coordinate value to an occupancy value. The choice of primitives may change the inductive bias of the optimization, leading to favoring different results when the number of primitives is insufficient.

For example, FIG. 7 illustrates the use of spheres 710a, planes 710b, quadrics 710c, and tiny neural implicit networks (such as tiny multilayer perceptrons 710d). FIG. 7 also illustrates a progression from a small number of primitives 720a to an intermediate number of primitives 720b to a large number of primitives 720c.

This progression is illustrated for spheres 710a, in which one sphere is a poor approximation of the groundtruth shape, an intermediate number of spheres is a better approximation, and many spheres is a good approximation. This progression is also illustrated for planes 710b, in which a few planes is a decent approximation of the groundtruth shape, an intermediate number of planes is a better approximation, and many planes is a good approximation.

This progression is illustrated for quadrics 710c, in which one quadric is a poor approximation of the groundtruth shape, an intermediate number of quadrics is a better approximation, and many quadrics is a good approximation. This progression is illustrated for tiny MLPs 710d, in which a few MLPs are a decent approximation of the groundtruth shape, an intermediate number of MLPs is a better approximation, and many MLPs are a good approximation. Hence, FIG. 7 illustrates that a number of primitives used to provide a good fit for a three-dimensional (3D) shape may vary by the family of primitives, but in general if many primitives are used, it is possible to construct a CSG model that is a good fit for the groundtruth shape.

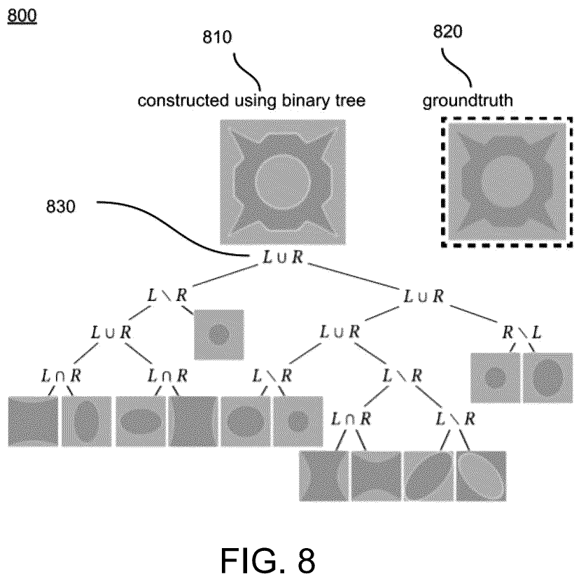

FIG. 8: Constructing Object from Binary Tree

FIG. 8 illustrates comparison 800 between an object constructed using a binary tree and a corresponding groundtruth object, in accordance with some implementations. More specifically, FIG. 8 illustrates a comparison 800 between an object constructed based on a CSG model (a binary tree with primitives as leaves and operators as nodes) in accordance with some implementations and a groundtruth shape of the object. Such a comparison is illustrated using a comparison of two-dimensional (2D) cross-sections.

The object constructed using a binary tree 810 and the groundtruth object 820 are a good match, in that they share the same occupancy function. In essence, the binary tree provides an efficient representation for the object. The representation can be utilized in a virtual environment to render a view of the object with high computational efficiency, since storage costs for storing the CSG model that includes binary tree are lower than that to store a mesh or other representation of the object, and since computational costs for constructing the object from the CSG model are moderate.

For example, the object constructed using a binary tree 810 is generated from a binary tree 830 including a number of nodes, each node being associated with a Boolean operation. The binary tree 830 also includes leaves, each being associated with parameters defining a primitive. Hence, FIG. 8 illustrates an example of a binary tree 830 that includes Boolean operations as nodes and primitives as leaves to construct the CSG object constructed using the binary tree 810 that matches the groundtruth object 820.

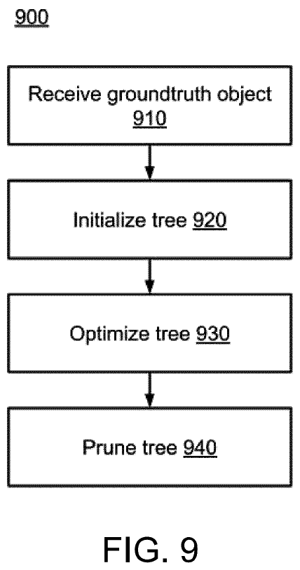

FIG. 9: Building Binary Tree from Groundtruth Object

FIG. 9 illustrates an example method 900 to build a binary tree from a groundtruth object, in accordance with some implementations. The method involves aspects of initialization, pruning, primitive choices, and parameterization of Boolean parameters.

Method 900 includes aspects of initialization. In some implementations, the method starts with a randomly initialized binary tree that consists of fuzzy Boolean nodes corresponding to continuous Boolean operators and primitive shapes represented as soft occupancy functions. As the tree complexity is unknown, an implementation may simply initialize a large binary tree (e.g., 4096 primitive shapes or another large number, depending on the usage scenario) to reduce the chance of having an insufficient number of primitives.

In some implementations, the parameters of the Boolean and primitive nodes may be initialized with a uniform distribution between −0.5 and 0.5, but this is only an example, and other values may be used at initialization. After training, an implementation may simply prune out redundant primitive/Boolean nodes with post-processing. As an alternative to a randomly initialized binary tree, the binary tree may be initialized using the results of generative AI, as discussed with respect to FIGS. 2A-2B and FIGS. 12-14.

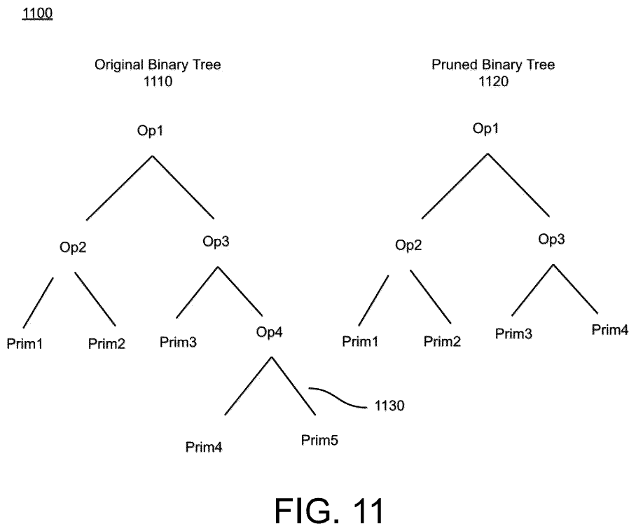

Method 900 also includes aspects of pruning. To determine redundant nodes, implementations may follow a definition in which, given a Boolean node and its two child subtrees, if a subtree can be replaced with a full function (soft occupancy with all 1s) or an empty function (soft occupancy with all 0s) without changing the output after the Boolean operation, then this node is deemed redundant and may be removed. An additional example of pruning is discussed in FIG. 11.

Such a redundancy definition may be generalized to fuzzy Boolean operations by setting a small threshold (e.g., maximum soft occupancy error of 10⁻³) to determine whether the difference after replacing a subtree with a full function or empty function is small enough to satisfy the threshold. An example of the effectiveness of such a simple pruning strategy to greatly reduce the complexity of the optimized binary tree, the binary tree illustrated in FIG. 8 includes only 13 primitives (from the large number of primitives, such as 128 primitives, which were present in the original tree).

Method 900 also includes aspects of primitive choices. In terms of the choice of primitives, there may be a variety of possible primitives as illustrated in FIG. 7 (i.e., spheres, planes, quadrics, tiny MLPs, etc.). However, implementations may use quadric surfaces in various discussed examples partly due to their popularity in use cases.

Also relevant, using a less expressive primitive (compared to MLPs) gives a clearer signal on the performance of the proposed Boolean node. This is because an expressive primitive family, such as a big neural network (such as using MLPs), is often able to fit a shape well even without using any Boolean operations.

Method 900 also includes aspects of parameterization of Boolean parameters. A possible side effect of having a unified Boolean operator lies in the possibility of not converging to one of the Boolean operations. One may alleviate this issue by parameterizing c with [symbol] ⁴ as c=softmax(sin(w\tilde{c})·t) where t∈ [symbol] is the temperature.

It is possible to leverage the temperatured SoftMax to ensure the resulting c lands on a vertex of the barycentric coordinate by increasing the temperature value t. This is because when t goes to infinity, the result of the temperature softmax converges to a one-hot vector, a vector that contains only one “1” and many “0” for the rest of the component. Some implementations may set the temperature t to a high value (e.g., t=10³) to encourage c to be numerically close to a one-hot vector for most parameter choices of \tilde{c}. The sine (sin) function is used to ensure Boolean operator type can still be changed easily in the later stage of the optimization. Without the sin function, changing c may involve a large number of iterations when \tilde{c} has a large magnitude because each gradient update only updates \tilde{c} a little bit.

This parameterization of c converges to a one-hot vector in a variety of test cases, even though implementations only softly encourage most parameter choices of \tilde{c} to be one-hot vectors. This behavior may occur because any in-between operations have occupancy values away from 0 or 1, whereas the target shape has binary occupancy values. Hence, converging to in-between operations can still occur when imperfect fitting happens.

Method 900 also includes aspects of optimization. One may define the loss function as the mean square error between the output occupancy from the binary tree and the groundtruth occupancy, evaluated on some sampled 3D points. Such sampled 3D points establish which regions of space fall within the occupancy functions. As an example of the sampled points, the points may be approximately 40% on the surface, 40% near the surface, and 20% randomly in the volume. In some implementations, the sampled points may be regenerated every few iterations (e.g., 10) to make sure that most areas in the volume are sampled.

Because the tree is differentiable with respect to the primitives and Boolean parameters, due to the use of continuous values for these parameters, implementations may use a continuous optimizer, such as the ADAM optimizer or another appropriate optimizer to update the primitive/Boolean parameters until the output occupancy matches the groundtruth. Such an optimizer uses techniques based on gradient descent, which leverages the continuous aspects of the tree parameters to cause the tree parameters to converge onto values that match the groundtruth occupancy function.

Method 900 begins at block 910. At block 910, a groundtruth object is received. In some implementations, the groundtruth object may be a visual hull. Such a visual hull is obtained from at least one mesh associated with an object's three-dimensional (3D) form. In some implementations, the visual hull may be obtained by acquiring two-dimensional (2D) images of a subject using a series of virtual cameras from a variety of angles and combining these images using techniques such as volume carving and/or shape-from-silhouette to establish as a visual hull a closed watertight manifold mesh corresponding to the object. The visual hull defines an occupancy function corresponding to the form of the object. Such an occupancy function may act as a groundtruth occupancy function. However, in other implementations, the occupancy function defining the groundtruth object may be obtained in other ways. Block 910 may be followed by block 920.

At block 920, a binary tree is initialized. In some implementations, the tree may be initialized as a large, potentially full binary tree with random parameters. For example, a large tree may be a tree with 4096 primitives and a corresponding number of Boolean operations. For example, the random values may be initialized based on a uniform distribution between −0.5 and 0.5. However, this particular random initialization is only an example, and other random initialization is also possible. Also, instead of a random initial tree, there may be an initial tree provided using generative AI. Also, a different number of primitives may be present in various implementations. Block 920 may be followed by block 930.

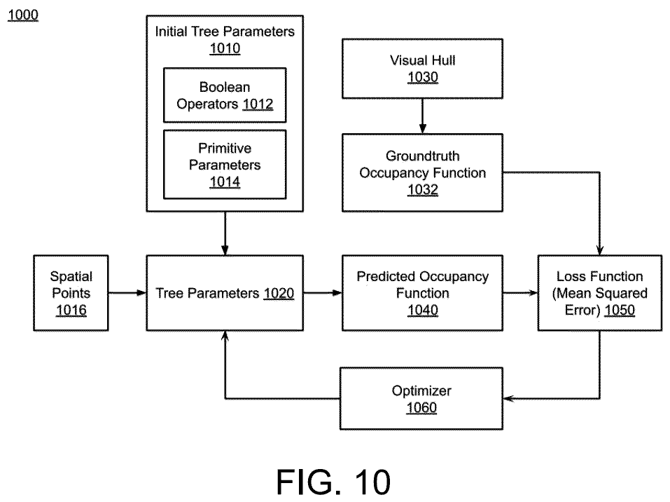

At block 930, the tree is optimized. Here, optimizing refers to improving the fit between the CSG model defined by the binary tree and the groundtruth model defined by the visual hull. For example, the optimizing may take advantage of the continuous aspects of the binary tree by using optimization techniques that involve gradient descent. For example, in the optimizing, values of the Boolean operations and values of the parameters of the CSG primitives for the binary tree may be identified by minimizing an error between an occupancy function of the CSG model and the groundtruth occupancy function of the 3D object. Additional aspects of optimizing a tree are presented in FIG. 10.

In some implementations, block 930 may be followed by block 940 for pruning. However, pruning is optional and the results of the optimization from block 930 may be provided as results. However, because the binary tree at this stage may include a large number of leaves and nodes, the pruning may be helpful as a way to reduce redundancy in the tree, making the tree more manageable and requiring the use of fewer resources.

At block 940, the tree is pruned. Once the tree is pruned, the tree may be provided as a representation of the CSG model. As discussed, the pruning may involve removing subtrees without any effect on the output of the tree, or with a very small effect on the output of three that is less than a threshold. The tree may be further modified as discussed in the context of FIGS. 2A-2B and FIGS. 4A-4B to incorporate rigging/skinning information and texture/material information into the CSG model.

### FIG. 10: Optimizing Binary Tree

FIG. 10 illustrates a block diagram to optimize a binary tree using a method 1000, in accordance with some implementations. As noted above, a CSG may be defined by a tree with Boolean operators as the nodes and primitives as the leaves. Optimizing a binary tree improves the goodness of fit between a volume defined by a binary tree and a visual hull to be matched. For example, the optimizing process begins with initial tree parameters 1010.

The initial tree parameters 1010 may include Boolean operators 1012 (nodes of the binary tree) and primitive parameters 1014 (leaves of the binary tree). In some implementations, the Boolean operators 1012 may be represented using continuous values, such as by barycentric coordinates. Such a continuous representation facilitates gradient descent training of the binary tree.

The initial tree parameters 1010 may include Boolean operators 1012 and primitive parameters 1014 that are set to random values prior to optimization. In some implementations, these random values may be initialized based on a uniform distribution between −0.5 and 0.5 or another approach to initializing using random values. Alternatively, the Boolean operators 1012 and primitive parameters 1014 may be set to initial values by a generative AI model prior to optimization. The initial tree parameters 1010 are supplied to a set of tree parameters 1020 to be optimized. The optimization is intended to cause a good fit between the CSG model corresponding to the binary tree and the groundtruth shape (which may be from the visual hull).

The optimization process of FIG. 10 may operate as follows. There may be a set of tree parameters 1020 corresponding to the continuous Boolean operators and the continuous values of tree parameters 1020 defined in the binary tree being optimized. Spatial points 1016 are fed into the tree parameters 1020. Some of the spatial points 1016 are inside of the CSG model that is to correspond to the visual hull and some of the spatial points 1016 are not inside of the CSG model that is to correspond to the visual hull.

Some of the spatial points 1016 may fall directly on the surface of the CSG model that is to correspond to the visual hull. In some implementations, there may be approximately 40% of the spatial points 1016 on the surface, 40% of the spatial points 1016 near the surface, and 20% of the spatial points 1016 inside the volume.

Once the spatial points 1016 are provided into the tree with tree parameters 1020, each point of the spatial points 1016 is associated with a predicted occupancy function 1040. In the optimization process, a visual hull 1030 may be obtained (a groundtruth visual hull) that the CSG is to match. Such a visual hull 1030 yields a groundtruth occupancy function 1032, establishing which points fall inside the volume of the visual hull 1030, which points fall on the surface of the visual hull 1030, and which points fall outside of the visual hull 1030. However, the groundtruth occupancy function 1032 is not limited to originating from the visual hull, and some implementations obtain information for the groundtruth occupancy function 1032 via other sources/mechanisms.

For example, as the spatial points 1016 are fed into the binary tree defined by tree parameters 1020 and a predicted occupancy function 1040 results as output, the predicted occupancy function 1040 and the groundtruth occupancy function 1032 are fed into a loss function 1050. In some implementations, the loss function 1050 may be a mean squared error loss function 1050. In some implementations, the loss function 1050 may be any other suitable function that indicates the difference between the groundtruth occupancy function 1032 and the predicted occupancy function 1040. The results of the loss function 1050 may be supplied to an optimizer 1060.

For example, computing the difference for the loss function 1050 may include sampling the groundtruth occupancy of the 3D object to identify a plurality of groundtruth points, determining corresponding modeled points obtained based on the CSG model, and computing an error by pairwise comparison of points from the plurality of groundtruth points and corresponding modeled points.

In some implementations, optimizer 1060 may use gradient descent techniques. For example, the optimizer 1060 may be an adaptive moment estimation (ADAM) optimizer. Such an optimizer 1060 tracks changes associated with partial derivatives of variables in the tree parameters 1020. These partial derivatives yield a gradient, which is a vector indicative of adjustments to tree parameters 1020 to control the loss function 1050. The tree parameters 1020 include Boolean operators and primitive parameters. The gradient may be computed via a backpropagation technique.

The calculation of predicted occupancy function 1040, loss function 1050, and optimization 1060 to update tree parameters 1020 may be performed two or more times till a stopping criterion is met (e.g., the loss function output meets a threshold, computational budget is exhausted, change in loss function output in consecutive iterations falls below a threshold, etc.) For example, minimizing the error may include iteratively modifying the values of the Boolean operations and the values of the parameters of the CSG primitives in the binary tree until the error between the occupancy function of the CSG model and the groundtruth occupancy function of the 3D object is less than a threshold value.

Alternatively, in some implementations a stopping criterion may include at least one of: the difference between the occupancy function of the CSG model and the groundtruth occupancy function of the 3D object falling below a threshold, a change between the occupancy function of the CSG model between consecutive iterations falling below a change threshold, a computational budget being exhausted, and/or the loss function satisfying another criterion or criteria.

The iterations may be repeated for a set number of epochs, where each epoch corresponds to a respective set of spatial points 1016. The optimization continues (with additional epochs) until the optimization permits the tree parameters 1020 to have a predicted occupancy function 1040 that matches groundtruth occupancy function 1032 or otherwise has a loss function 1050 (such as a mean square error) that keeps the change of the value of the loss function 1050 less than a threshold value.

### FIG. 11: Pruning Binary Tree

FIG. 11 illustrates an example 1100 of pruning a binary tree, in accordance with some implementations. For example, there may be an original binary tree 1110 and a pruned binary tree 1120. Original binary tree 1110 includes a series of operations at the nodes (Op1, Op2, Op3, and Op4) and a series of primitives at the leaves (Prim1, Prim2, Prim3, Prim4, and Prim5).

Before pruning, the original binary tree 1110 has been constructed as a representation of a groundtruth occupancy function. Pruning permits the binary tree to remain a good representation of the groundtruth occupancy function while greatly reducing the complexity of the optimized binary tree.

FIG. 11 illustrates that there may be a subtree 1130 of original binary tree 1110 that can be pruned, resulting in pruned binary tree 1120. After the pruning, Op4 and Prim5 have been replaced with Prim4. As discussed, the pruning may occur for a subtree that may be replaced with a full (soft occupancy with all 1s) or an empty (soft occupancy with all 0s) without changing the output. However, due to the continuous nature of various implementations, a very small occupancy threshold error (such as a value of 10-3 or less) may not obstruct the occurrence of pruning.

Thus, the pruning may include pruning the binary tree to remove redundant subtrees to obtain a pruned binary tree by visiting nodes in the tree in post-order and deleting redundant noes, wherein a node is redundant when replacement of the node with a full object or an empty object results in a difference in an output of a Boolean operation associated with the node in the binary tree that is less than a change threshold.

The pruning may allow for traversing the pruned binary tree using a linear time traversal algorithm on a forward pass in post-order using a stack when using the pruned binary tree to infer properties of the CSG model of the 3D object.

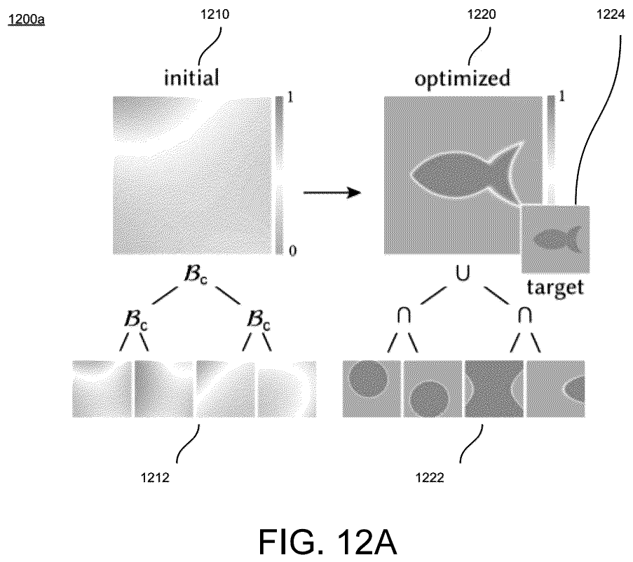

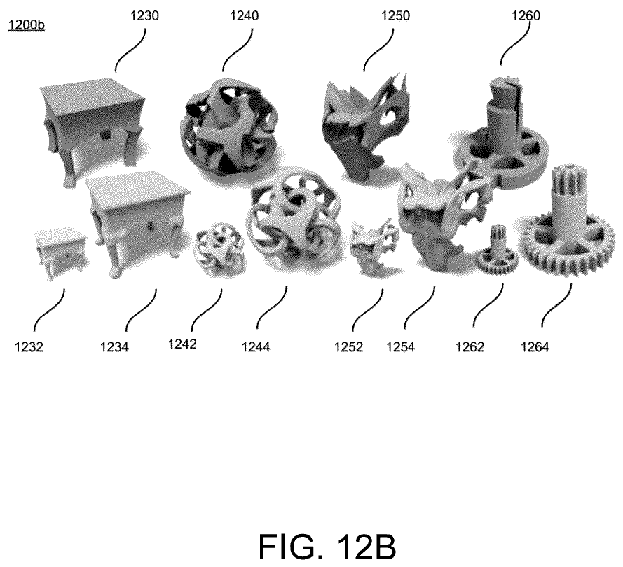

### FIG. 12A: Performing Inverse CSG Fitting

FIG. 12A illustrates an example of a pipeline 1200 to perform inverse constructive solid geometry (CSG) fitting, in accordance with some implementations. Pipeline 1200 begins with an initial object 1210 defined by an initial binary tree 1212. Initial binary tree 1212 has randomly initialized primitives and Boolean operations. Implementations then perform continuous optimization on both the primitives and the Boolean operations in the initial binary tree 1212. Upon such continuous optimization (e.g., over one or more iterations), the initial object 1210 is transformed into an optimized object 1220. Optimized object 1220 is defined by an optimized binary tree 1222 that fits the target object 1224.

For example, the initial binary tree 1212 begins with continuous Boolean operations and random primitives. After optimization, the optimized binary tree 1222 includes specific Boolean operations and primitives with sharp edges. Accordingly, the optimized binary tree 1222 defines an optimized object 1220 that is a good match for target object 1224. Hence, using techniques presented provides a high quality CSG model of an object by providing CSG fitting using continuous optimization.

### FIG. 12B: Using Various Fitting Techniques

FIG. 12B illustrates inverse CSG fitting according to various techniques for some example objects 1200b, in accordance with some implementations. FIG. 12B shows a groundtruth table object 1232, a groundtruth circular solid object 1242, a groundtruth sculpture object 1252, and a groundtruth machine part object 1262. There may be various techniques used to perform inverse CSG fitting for these objects. Two techniques for inverse CSG shown in FIG. 12B are using min/max operators and continuous optimization as described herein.

For example, FIG. 12B illustrates using min/max operators for a table object 1230, a circular solid object 1240, a sculpture object 1250, and a machine part object 1260. FIG. 12B also illustrates inverse CSG fitting using continuous optimization as described herein for a table object 1234, a circular solid object 1244, a sculpture object 1254, and a machine part object 1264.

Using this continuous optimization technique results in higher-quality results. Table object 1234 (obtained using continuous optimization) is a better fit to groundtruth table object 1232 than table object 1230 (obtained using min/max operators). Circular solid object 1244 (obtained using continuous optimization) is a better fit to groundtruth circular solid object 1242 than circular solid object 1240 (obtained using min/max operators). Sculpture object 1254 (obtained using continuous optimization) is a better fit to groundtruth sculpture object 1252 than sculpture object 1250 (obtained using min/max operators). Machine part object 1264 (obtained using continuous optimization) is a better fit to groundtruth machine part object 1262 than machine part object 1260 (obtained using min/max operators).

For example, machine part object 1264 (obtained using continuous optimization) retains the toothed-circular shape at its bottom whereas machine part object 1260 (obtained via min/max operators) does not include this detail.

In another example, the circular solid object 1244 (obtained using continuous optimization) has smooth edges that match those of the groundtruth circular solid object 1242, whereas the circular solid object 1240 (obtained via previously-proposed min/max operators) has jagged/discontinuous edges that do not match those of the groundtruth circular solid object 1242. FIG. 12B also shows that for both objects with sharp edges as well as those with smooth edges/surfaces, the described implementations produce CSG models that permit accurate reconstruction.

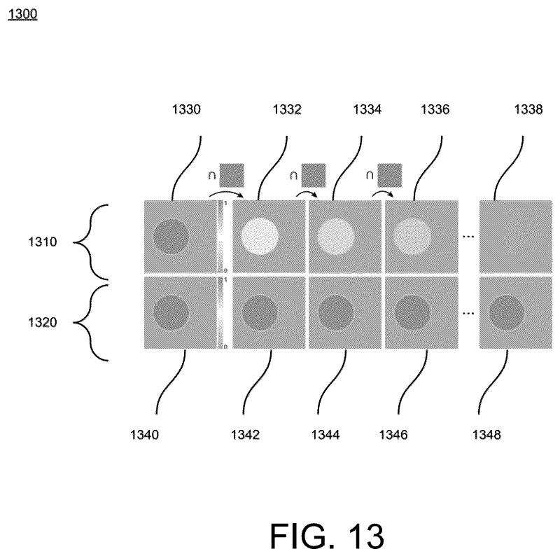

### FIG. 13: Using Various Boolean Operators

FIG. 13 illustrates the use of various types of Boolean operators 1300, in accordance with some implementations. In FIG. 13, there are two rows of results of applying soft Boolean operators, top row 1310 and bottom row 1320. The top row 1310 illustrates an R-function, and the bottom row 1320 illustrates an operator according to some implementations.

The R-function does not satisfy the axioms characterizing the behavior of intersection. The R-function generates outputs that do not align with crisp intersection. Instead, the R-function generates a nearly empty shape when intersecting with the full shape multiple times. In contrast, implementations match the behavior of a crisp intersection.

For example, the top row 1310 begins with an initial circular primitive 1330. Multiple intersection operators defined by an R-function yield circular shape 1332, circular shape 1334, circular shape 1336, and final circular shape 1338. As the R-function intersects with a full shape multiple times, the R-function generates an empty shape as the final circular shape 1338.

By contrast, in the bottom row (the present implementations) the present implementations match the behavior of a crisp intersection. Multiple intersection operators defined herein yield circular shape 1342, circular shape 1344, circular shape 1346, and final shape 1348. Hence, the present implementation preserves the full shape.

### FIG. 14: Vanishing Gradients

FIG. 14 illustrates aspects of avoiding vanishing gradients 1400, in accordance with some implementations. FIG. 14 illustrates a traditional max operator 1402 and an operator according to implementations 1404. FIG. 14 illustrates the importance of avoiding vanishing gradients in an inverse CSG for fitting the union of two circles. Use of the traditional max operator 1402 to reconstruct the shape suffers from vanishing gradients, leading to a primitive remaining unchanged throughout the optimization and thus failing to reconstruct the target shape.

For example, the traditional max operator 1402 may begin with an initial model 1410 that corresponds to an initial binary tree 1414. Initial model 1410 is transformed into an optimized model 1412 that corresponds to an optimized binary tree 1416. Because one of the primitives (right hand primitive) remains unchanged in optimized binary tree 1416, results from the optimized model 1412 differ from the target shape 1418.

In contrast, various implementations 1404 provide techniques that avoid vanishing gradient and can a generate shape that matches the groundtruth. For example, the operator according to implementations 1404 may begin with an initial model 1420 that corresponds to an initial binary tree 1424. Initial model 1420 is transformed into an optimized model 1422 that corresponds to an optimized binary tree 1426 that has different primitives than the initial binary tree 1424. With both primitives changed in optimized binary tree 1426, optimized model 1422 matches the target shape 1428 well.

### FIG. 15: Naïve Bilinear Interpolation

FIG. 15 illustrates aspects of naïve bilinear interpolation 1500, in accordance with some implementations. FIG. 15 illustrates an occupancy graph at 1510 and a corresponding interpolation diagram 1520. Naïve bilinear interpolation illustrates interpolation between a union operator X∪Y 1512 at the top left of interpolation diagram 1520 and a difference operator Y\X 1518 at the bottom right of interpolation diagram 1520. Interpolation diagram 1520 also shows an intersection operator X∩Y 1516 at the top right of interpolation diagram 1520 and a difference operator X\Y 1514 at the bottom left of interpolation diagram 1520.

To create a unified fuzzy Boolean operator that is differentiable with respect to the type of Boolean operation (i.e., intersection, union, difference), an approach used in various implementations is to interpolate their respective membership functions using a set of interpolation control parameters c. Implementations may use an interpolation scheme that is continuous and monotonic in the parameters c such that the interpolation function avoids unnecessary local minima.

A naïve solution is to use bilinear interpolation between the four Boolean operations ƒ_{X∩Y}, ƒ_{X∪Y}, ƒ_{X\Y}, ƒ_{Y\X}. While such interpolation can look smooth, bilinear interpolation exhibits non-monotonic changes and creates local minima in the interpolated occupancy (as illustrated in FIG. 15 at 1510, corresponding to the interpolation between opposite corners of the interpolation diagram 1520). This is because bilinear interpolation implicitly forces the average between X∪Y 1512 and Y\X 1518. A similar situation applies between X∩Y 1516 and X\Y 1514.

For example, FIG. 15 shows on interpolation diagram 1520 that the corners correspond to operations X∪Y 1512, X\Y 1514, X∩Y 1516, and Y\X 1518. When forcing bilinear interpolation between opposite corners, suboptimal results may result.

In many cases, these averages are not equivalent and thus the constraint forces the interpolation to be non-monotonic. If the interpolation is non-monotonic, the interpolation can result in local minima. This can cause the gradient descent to terminate at a local minimum instead of a global minimum, which is suboptimal. Some implementations may use tetrahedral barycentric interpolation as discussed with respect to FIG. 6 that overcomes this issue.

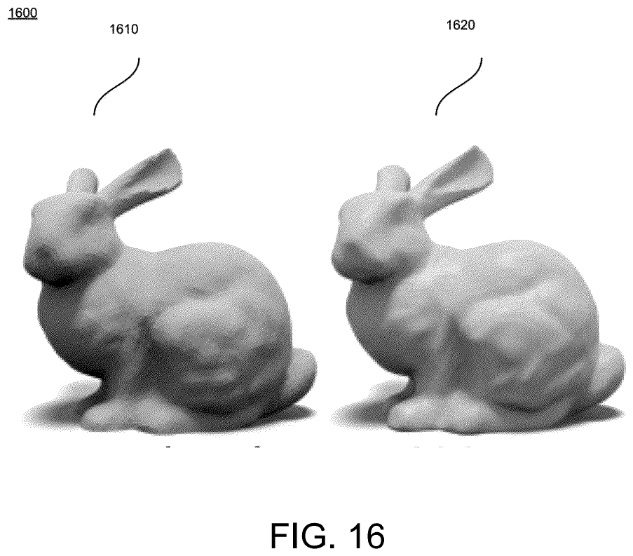

### FIG. 16: Groundtruth Shape AND CSG Shape

FIG. 16 illustrates a groundtruth shape and a corresponding constructive solid geometry (CSG) shape 1600, in accordance with some implementations. FIG. 16 illustrates a groundtruth shape 1610. FIG. 16 also illustrates a CSG output 1620 generated by implementations. FIG. 16 illustrates that groundtruth shape 1610 and CSG output 1620 are similar, including soft shape characteristics such as surface undulations on the animal's body, as well as the soft shape of its cars. Hence, FIG. 16 shows that implementations produce high-quality results where computationally efficient CSG models can be used in virtual environments to provide arbitrary 3D objects with high fidelity to corresponding groundtruth objects (e.g., mesh-based models).

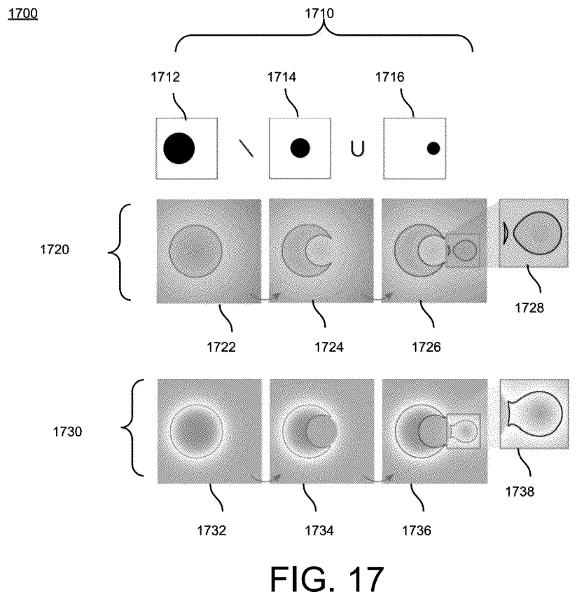

FIG. 17: Providing Soft Blending Results Free from Artifacts

FIG. 17 illustrates an example of a soft blending result that includes artifacts and another soft blending result that is free from artifacts 1700, in accordance with some implementations. For example, FIG. 17 illustrates a blending 1710 that includes blending a large circle primitive 1712 as a difference operation with a medium circle 1714 that is blended as a union operation with a small circle 1716.

Prior techniques that use the soft union presented in 1720 to compute Boolean expression leads to “floating island” artifacts. These artifacts occur because Boolean operations on the signed distance function do not output a correct signed distance function. For example, the soft union presented in 1720 begins with the large circle primitive 1722, differences the large circle primitive 1722 with the medium circle primitive 1714 to obtain an intermediate result 1724, and performs a union operation on the intermediate result 1724 with the small circle primitive 1726, yielding an output with a “floating island” 1728 (shown as a zoomed in view of output 1728 with a “floating island” 1728).

Using the Boolean operator according to various implementations as illustrated in 1730 operates on the occupancy function and remains an occupancy function after Boolean operations. This leads to soft blending results that are free from artifacts. For example, the soft union presented in 1730 begins with the large circle primitive 1732, applies a difference operator with the medium circle primitive 1714 to obtain an intermediate result 1734, and applies the union operator to the intermediate result 1734 and the small circle primitive 1736 to obtain an output 1738. Note that the zoomed-in view of the output 1738 shows a contiguous object with no “floating island.” The soft blending result per implementations described herein are thus free from artifacts.

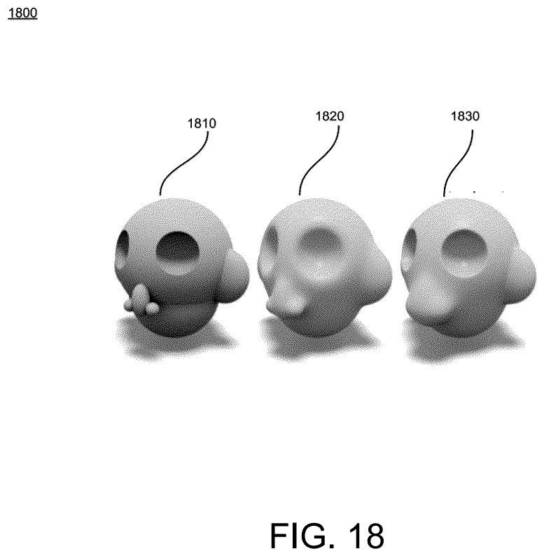

### FIG. 18: Hard and Adaptive Smoothness

FIG. 18 illustrates examples of hard and adaptive smoothness in constructive solid geometry (CSG) 1800, in accordance with some implementations. FIG. 18 illustrates hard Booleans 1810, crisp and smooth outputs 1820, and controlling the smoothness adaptively 1830 at the primitive level. Unlike classic CSG which can only model hard Booleans 1810, techniques described herein enable both crisp and smooth outputs 1820 and controlling the smoothness adaptively 1830 at the primitive level. Such adaptive smoothness allows for smooth transitions between primitives rather than requiring sharp edges.

Using fuzzy Boolean operators in CSG gives the ability to model both mechanical objects with crisp edges and smooth organic shapes with the same framework. Specifically, if the underlying implicit shapes are crisp binary occupancy functions, the implementations provide the same sharp results as the traditional CSG. If the input shapes are soft occupancy functions, the implementations output smooth shapes based on the “softness” present in the input shape.

This capability permits implementations to obtain visually indistinguishable results compared to the popular smoothed min/max operations on the signed distance function. Moreover, the techniques according to implementations are free from artifacts caused by discrepancy between the input and the output (see FIG. 17). This is because the techniques according to implementations ensure that no such variation can occur. Specifically, this is true because mathematicians have proven that the Fuzzy Logic operators can ensure that if the input is a “soft occupancy” function, then the output will remain as a soft occupancy function. Because both the input and the output are valid soft occupancy functions, there is no discrepancy between them. Implementations are built on top of this theoretical framework in Fuzzy Logic.

Both the input and the output are guaranteed to be soft occupancy functions. This is different from the other methods in that their outputs are not signed distance functions, even though the input is. Previous techniques take a signed distance function as the input. However, after performing min/max operators, the output is no longer a signed distance function. In other words, there is a discrepancy between input and output using previous methods.

As the smoothness is controlled at the primitive level, implementations may easily have adaptive smoothness across the shape by simply changing the softness of each primitive occupancy (see FIG. 9). Specifically, implementations consider primitive shapes represented as the signed distance function s, and implementations convert the primitive shapes to occupancies with the sigmoid function sigmoid (t·s) with different softnesses by adjusting the positive temperature parameter t.

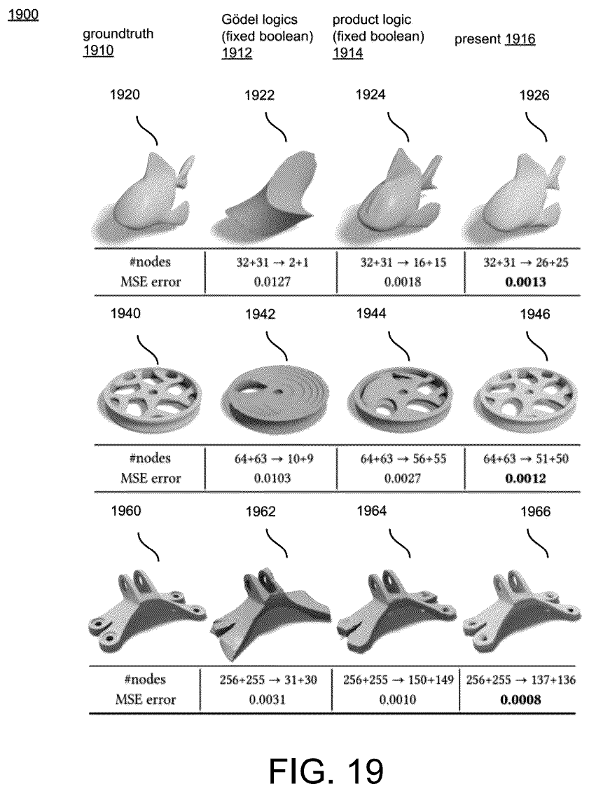

### FIG. 19: Types of Fitting

FIG. 19 illustrates examples of various types of fitting 1900, in accordance with some implementations. Some implementations allow optimization of the type of Boolean operations. This leads to a better fitting result compared to the product logic and the Gödel logic with (randomly initialized) fixed Boolean operations. Implementations as shown in FIG. 19 present the total number of nodes (primitive+Boolean) before and after the optimization with pruning, showcasing improvements over different initial tree complexities. FIG. 19 also shows the mean squared error (MSE) on the occupancy evaluated on 2 million points sampled uniformly.

FIG. 19 illustrates that there are groundtruth objects 1910 and three types of CSG models that fit the groundtruth objects 1910. These CSG models are Gödel logics models 1912, product logic models 1914, and present models 1916. Both Gödel logics models 1912 and product logic models 1914 include fixed Booleans, while the models 1916 use continuous Booleans as per various implementations described herein.

In FIG. 19, a groundtruth fish object 1920 is shown with corresponding Gödel logics fish object 1922, a product logic fish object 1924, or a fish object 1926 per a CSG model obtained using implementations described herein that use continuous Booleans. These fish objects are accompanied by a total numbers of nodes (primitive and Boolean) before and after the optimization and a MSE error for these fish objects.

In FIG. 19, a groundtruth wheel object 1940 is shown with corresponding Gödel logics wheel object 1942, a product logic wheel object 1944, or a wheel object 1946 per a CSG model obtained using implementations described herein that use continuous Booleans. These wheel objects are accompanied by a total numbers of nodes (primitive and Boolean) before and after the optimization and a MSE error for these wheel objects.

In FIG. 19, a groundtruth engine bracket object 1960 is shown with corresponding Gödel logics engine bracket object 1962, a product logic engine bracket object 1964, or an engine bracket object 1966 per a CSG model obtained using implementations described herein that use continuous Booleans. These engine bracket objects are accompanied by a total numbers of nodes (primitive and Boolean) before and after the optimization and a MSE error for these saddle objects.

As seen in FIG. 19, using Gödel logics results in a large decrease in models with a small number of nodes (primitives and Booleans), e.g., from (32+31) to (2+1) for a fish object, from (64+63) to (10+9) for a wheel object, and from (256+255) to (31+30) for an engine bracket object, where the first number denotes the number of leaves and the second number denotes the number of Boolean nodes. However, the MSE error is relatively high, indicating the poor quality of these models in reproducing the groundtruth. For example, the tail and fin of the fish is absent, and the fish shape overall does not resemble the groundtruth; the inner shape of the wheel is not correctly reproduced; and the holes in the engine bracket are not reproduced fully and the shape of the engine bracket is different.

Product logics results in a moderate decrease in the number of nodes (primitives and Booleans), but the MSE is significantly improved over Gödel logics. As seen in FIG. 19, using product logics results in a large decrease in models with a small number of nodes (primitives and Booleans), e.g., from (32+31) to (16+15) for a fish object, from (64+63) to (56+55) for a wheel object, and from (256+255) to (150+149) for an engine bracket object, where the first number denotes the number of leaves and the second number denotes the number of Boolean nodes. However, the MSE error is considerably better, indicating the high quality of these models in reproducing the groundtruth. For example, the tail and fin of the fish is now present, and the fish shape overall better resembles the groundtruth; the inner shape of the wheel is better reproduced; and the holes in the engine bracket are reproduced and the shape of the engine bracket is better reproduced.

CSG models obtained using implementations described herein (e.g., using continuous Booleans) not only result in a slight decrease in the number of nodes (primitives and Booleans), but also provide the lowest MSE values, which are also reflected in the high fidelity of the output shapes to the groundtruth. As seen in FIG. 19, using these CSG models results in only a slight decrease in models with a small number of nodes (primitives and Booleans), e.g., from (32+31) to (26+25) for a fish object, from (64+63) to (51+50) for a wheel object, and from (256+255) to (137+136) for an engine bracket object, where the first number denotes the number of leaves and the second number denotes the number of tree nodes.

However, these CSG models have the lowest MSE error provided in FIG. 19.

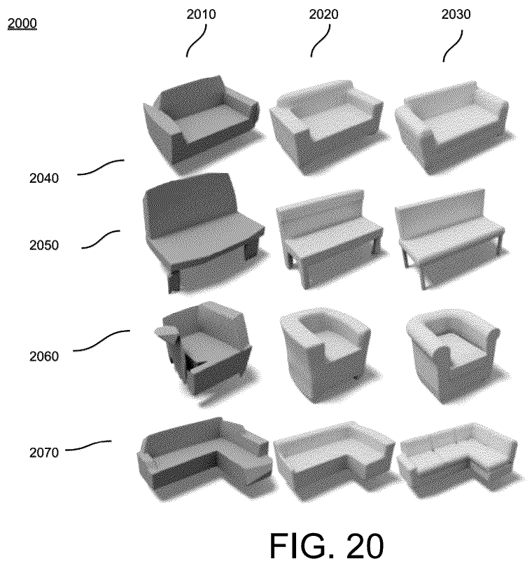

### FIG. 20: Improved Fitting to Groundtruth Shapes

FIG. 20 illustrates examples of fitting objects to groundtruth shapes 2000, in accordance with some implementations. FIG. 20 illustrates four models of furniture, in three columns. First column 2010 is a CSG model generated using other techniques. Second column 2020 is a CSG model according to some implementations. Third column 2030 is a groundtruth CSG model.

Row 2040 illustrates loveseats with armrests on either side of the furniture. Row 2050 illustrates benches. Row 2060 illustrates armchairs. Row 2070 illustrates L-shaped couches.

As seen in FIG. 20, implementations can obtain qualitative improvement in fitting the groundtruth shape over their approach. For example, the shape of the groundtruth couch in row 2040 is reproduced accurately in the second column 2020 (CSG model per implementations described herein) but exhibits problems (e.g., incorrect backrest) in first column 2010; the bench of the first column in row 2050 is taller and wider, and has a substantially different appearance than the groundtruth bench, whereas the second column 2020 matches the groundtruth well. Rows 2060 and 2070 also illustrate that CSG models per various implementations described herein have high accuracy in reproducing groundtruth shapes compared to prior techniques.

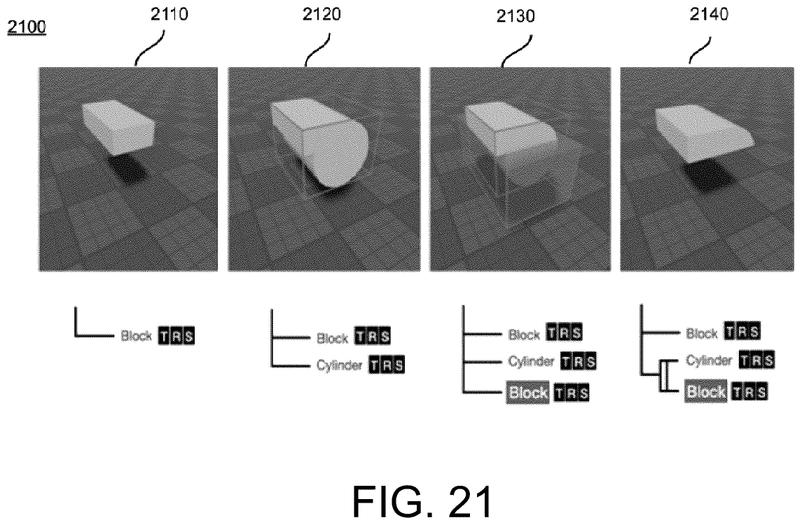

### FIG. 21: Building Binary Tree

FIG. 21 illustrates an example of building a binary tree 2100, in accordance with some implementations.

FIG. 21 illustrates an example model of the binary tree 2100, in accordance with some implementations. In accordance with an implementation, artificial intelligence engine 266 (as illustrated in FIG. 2A) uses natural language as an input for the creation of a CSG model from a visual hull representation.

Prior techniques either use polygonal meshes or use neural radiance field (NeRF) image-based approaches to train machine learning models that can provide a 3D model given a natural language prompt. These techniques provide a polygonal representation of the resulting 3D model that provides little to no flexibility for editing of the 3D model, does not provide optimal topology, and does not provide easy creation of levels of detail suitable for use at runtime when an object is placed in a virtual experience, game, or other application.

A user may design a 3D object in a studio application. The object may have many parts and connections. The designed object may have many parts and connections. The designed object may be stored as a CSG model. The evolution of the object through the design phases can be tracked and with user permission, used to train an AI model. The representation of the object as a CSG model allows easy incorporation allows easy incorporation of modifications that the user makes in an efficient manner. Hence, creation of an object is made easier by use of a CSG model as a representation because such a CSG model may be derived either by using continuous optimization techniques or AI techniques as discussed herein.

The implementations described herein leverage training of a neural network (or other machine learning model) based on a large dataset of geometric primitives that can be utilized to create a large variety of 3D models (e.g., constructive solid geometry (CSG) models). The “construction tree” contains non-destructive operations between the various primitives as well as their position, rotation, and scale in 3D space. Such a “construction tree” may be a binary tree defining the CSG model as discussed herein. This has the advantage of enabling training of the neural network to allow model parameters to be learnt that can enable use of the model for construction of elaborate 3D models. In some implementations, the versioning information for the 3D model is also used in the training set; this can advantageously provide information on the evolution of the 3D model over time across various versions, allowing model training to take into account model versioning.

Once a CSG model has been created from a natural language prompt, such a model can be optimized for runtime performance by sampling the primitive solid objects to convert them into the appropriate polygonal count keeping the UV map consistent. The CSG model is also more easily edited as a non-destructive tree is available and can be modified in an intuitive way and without affecting the validity of the entire model.

In some implementations, snapshots of the progress in building the final 3D model using CSG are recorded and used as training data for the neural network. This recording of snapshots provides additional context in the training data on the construction of 3D models from primitives, allowing the model to be trained to generate high quality output.

Once the model is trained, a user can procedurally generate a 3D model made of CSG components just by typing a natural language sentence descriptive of the object. Given the non-destructive nature of CSGs and how the entire tree is stored, the user can also edit any step of the process non-destructively by editing the properties of each part or by changing the type of Boolean operation to apply to them (union, separation, negation, etc.). This represents a significant advantage compared to polygon-based approaches that are difficult to edit without building custom higher-level controls.

According to various implementations, geometric primitives may be used as basic units in connection with constructing/reconstructing 3D models. According to various implementations, a one-to-many mapping may be used to map text (e.g., a word) to various primitives. For example, the word “house” can provide an old house through the model, made of different geometric primitives. Examples of a set of primitives may include a cube, sphere, wedge corner, wedge, and cylinder. Other and/or additional example primitives may be used.

In another example, several million polygons may be provided for 3D models. Such polygons and 3D models may be generated with parts coming together, so as to create still further polygons and 3D models. Such polygons and 3D models may be generated using parts and also Boolean operations that are performed on the parts. Hence, continuous optimization or AI techniques may effectively provide for such use of polygons and 3D models.

According to various implementations, the training may work with parts (which may be various geometric primitives). The parts may be put together without Boolean operations or may be added together with Boolean operations to make more complex 3D models. In a subtraction example, a Boolean operation may be performed to remove the lower part of a model. Hence, such training provides for ways of generating a CSG model that represents a complex 3D model.

In another example, several parts may be added together in Boolean add operations to obtain the groundtruth model (e.g., the model without the lower part). The evolution over time of the model may be tracked using the neural network, and the neural network may be trained as to how to combine primitives and Boolean operations to form models.

As an example, a snapshot of the user creation (e.g., as a user designs a 3D object) may be obtained periodically, e.g., every few minutes. Thus, for some inputs, the time-lapse development of the model can be seen. This time lapse is helpful to train the neural network. The snapshots are of the model as the model evolved during the process by which the user created it. As an example, a castle being built may involve several hundred parts and operations. A simple chair or flower perhaps may involve fewer (such as a few dozen) parts and operations.

Parts may be given a name or tags. Users may also be able to label the data with an exact name, and such name/tags may be used to infer the name for various other parts. The names/tags of the parts may be published in the marketplace.

As an example, a user may start with the cylinder, then add a block, then scale something upwards, truncate something, add something else, etc. during the course of building a 3D object. Even without the time snapshot, the whole tree is saved so that the user can still see what parts were put together and the operations that were done.

The final state of the construction tree may be seen in FIG. 21. As an example, if the construction tree is made up of several parts, the arrangement of parts of the construction tree including the branching can be seen. With the snapshots, information as to which part was added first, which part was added second, etc. can be seen.

According to various implementations, once the model is trained and is being used, a user may want a house, a tree, and so on, and then if the 3D object is built out of primitives instead of polygons, several advantages are provided. At the end, everything is reduced to polygons (e.g. triangles) in an engine and goes into the graphics card.

Trees may involve several thousand polygons, and if there are many trees, there could potentially be millions of polygons and the game may not run smoothly. Thus, it may be very difficult to operate on a triangular mesh. However, if everything starts from and is built with primitives, the creation of level of details including scaling preserves the overall shape of 3D objects.

This approach of using primitives provides advantage in terms of runtime optimization. Also, the primitives help create a physics capsule for collision. A representation has a lot more information than just a triangular message and permits users to tune up and down the fidelity and resolution in the engine and still have good performance.

As an illustration, if a user builds a house and the only thing the user does not like is the roof (e.g., the user wants the roof to be wider), the user may just grab the roof and scale in one direction. So, there is thus a non-destructive edit. This technique may be compared with grabbing vertices of a triangular mesh—the moment that a user grabs vertices in the triangular mesh and moves them, the user would not know what was there before and may not be able to put the triangles/vertices back.

According to various implementations, primitives may be created or manipulated inside a studio or other interface. Users may view and click on the different parts. For example, users may see a roof and windows and everything else, and can select them and then scale, rotate, and translate them.

As an example, a user may be procedurally generating a 3D model by typing or saying a natural language sentence (or by otherwise providing a natural language instruction). The user may say (or type) “a castle” and there may be many stored castles that use many different sets of primitives. When the user queries the neural network for a castle, the neural network may provide a generic castle. If the user says (or types), “I want a castle with a bridge, defense towers, and a flag on top,” then the neural network has additional elements to provide the user with a model that is more specific.

According to various embodiments, the training set is not generated only with 3D models but also other images in various kinds of media.

According to various implementations, the neural network may be based on stable diffusion technology.

FIG. 21 illustrates an example of building a binary tree, in accordance with some implementations. More particularly, FIG. 21 illustrates a binary tree being constructed through various stages of design of a 3D object. For example, the top part of FIG. 21 illustrates successive stages of building a 3D object using various CSG primitives. The bottom part of FIG. 21 illustrates a corresponding CSG that includes various primitives and their relationships as the 3D object is modeled. The binary tree positions the various primitives in 3D space (e.g., translation, rotation, and scale) and leverages Boolean operations (e.g., negate and union) to obtain the final 3D model (e.g., the image furthest to the right).

More specifically, FIG. 21 illustrates a binary tree that describes how the object is being built with Boolean operations and assembling of multiple primitives in accordance with some implementations. This approach is how the file is saved and contains the pieces that define the object.

For example, FIG. 21 may begin with CSG model 2110 with a block. FIG. 21 may continue with CSG model 2120 by adding a cylinder. FIG. 21 may continue with CSG model 2130 by removing a block. The end result of FIG. 21 is shown as a CSG model 2140. These primitives (e.g., blocks and cylinders) may be defined and related by Boolean operators and by various primitive parameters.

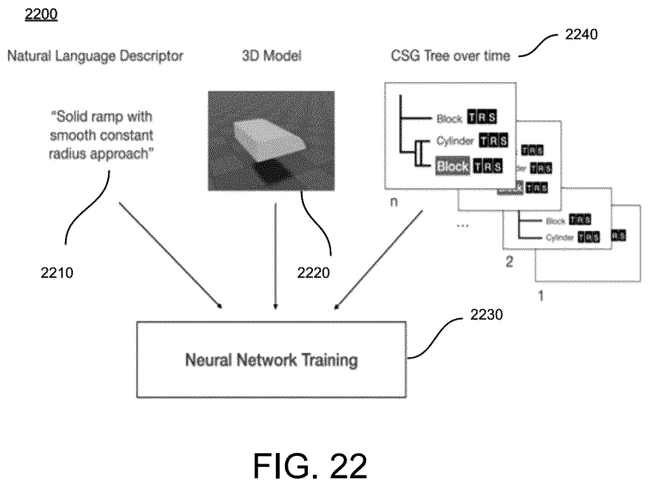

### FIG. 22: Example Inputs in Training a Neural Network

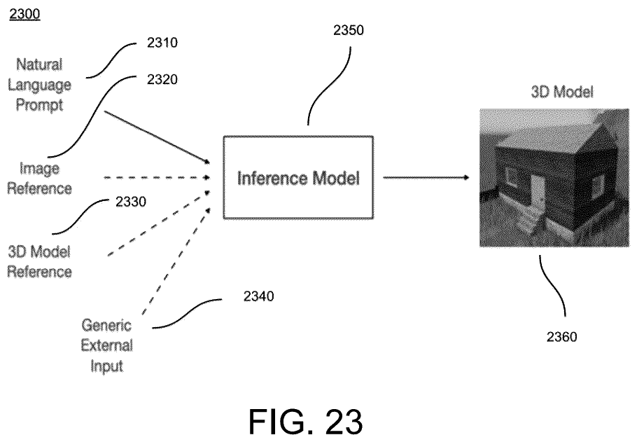

FIG. 22 illustrates example inputs in the training of a neural network 2200, in accordance with some embodiments. Other types of inputs (including combinations and modification thereof) are possible. Such a neural network, when trained, can have the ability to take various inputs and generate a corresponding 3D model by acting as an inference model, as discussed in FIG. 23.

In accordance with an implementation, FIG. 22 illustrates that there may be several types of information characterizing changes to a CSG model over time as users build it. There may be an initial object, such as a box (e.g., CSG model 2110). The initial object may be represented by a binary tree, as discussed herein. A user may add inputs to design and change the object in various ways. By using an AI model and/or other automated techniques to construct and modify the binary tree through the design stages, the user may provide training data used for neural network training 2230.

The training data may include user design instructions, such as voice prompts, text prompts, and other modeling inputs (e.g., from mouse, keyboard, touchscreen, etc.), defining primitives and then changing the relationship between the primitives, yielding the final state of the object in which everything is illustrated and the whole artifact is created as a CSG model.

The neural network training 2230 in FIG. 22 can be fed time snapshots of the binary tree over time 2240 as the use builds the binary tree, successively designing the object. Such time snapshots may allow the neural network training 2230 to take into account how models have changed over time in response to the various user inputs.

The neural network training 2230 may also consider the final 3D model itself 2220 and the natural language descriptor(s) 2210 (which may have been presented as text, audio, etc.) that the user may have provided (e.g., requesting the design of a “ramp” or another more detailed description, such as “Solid ramp with smooth constant radius approach”) that led to the generation of the final 3D model itself 2220. Such information may be used as appropriate for neural network training 2230, relating the user inputs to individual changes in the object and the final form of the object.

Subsequently, a subsequent user may also be able to work with the neural network trained in neural network training 2230. For example, a second user may interact with the neural network training 2230, providing more labeled training data and improving the performance of the neural network.

Alternatively, the trained neural network may be used by the implementations as an automatic inference model, as shown in FIG. 23. For example, a 2D screenshot of the 3D model may have been obtained by the neural network and then some other neural network input/output (e.g., a typed or spoken instruction). may be used to determine that the user wants a solid ramp with smooth constant radius. These are some examples of inputs and combinations thereof that may be used to train a neural network and use it to generate 3D objects.

FIG. 23: Use of Inference Model with Multiple and Heterogeneous Inputs

FIG. 23 illustrates an example inference model that can take multiple and heterogeneous inputs 2300, in accordance with some implementations. The inference model 2350 may then be used to generate a CSG model, such as 3D model 2360. For example, an inference model 2350 may correspond to a neural network constructed based on neural network training 2230.

FIG. 23 illustrates how the inference is obtained from an inference model 2350 based on various inputs, such as a natural language prompt 2310 or a related image reference 2320, in accordance with some implementations. For example, a natural language user input may be “I have this photo of a house. Give me a 3D model of this.” The related image reference 2320 may be an image that helps clarify the meaning of the natural language user input, such as by including a 2D photo of the house to clarify what the house looks like in 2D from a specified angle.

In another example, the user may provide a rough sketch of a 3D model (3D model reference 2330) that can be used as an input to the inference model 2350. As another example, the external input could be from a device or other input to convey a user preference (for example, a designated type of house). In another example, there may be generic external input 2340 that provides raw data to inference model 2350. These various types of information are provided to inference model 2350. Inference model 2350 then generates 3D model 2360 accordingly.

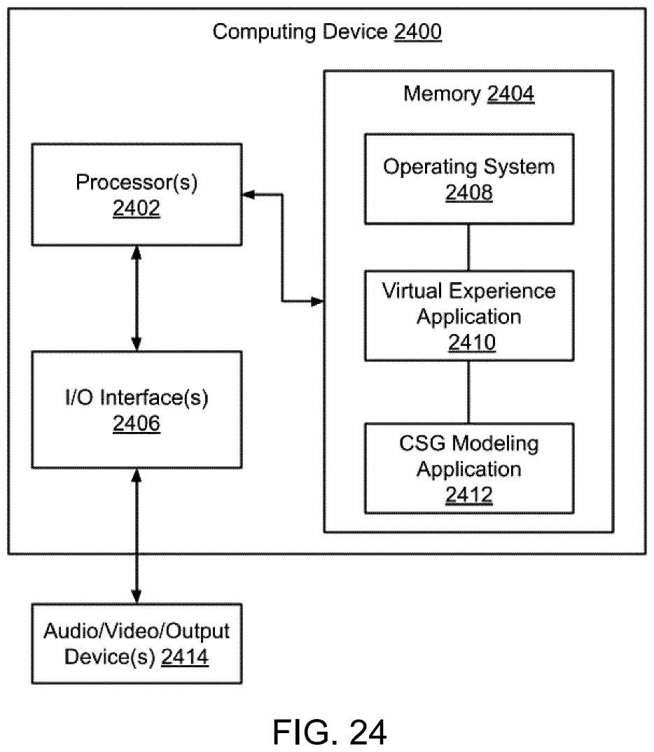

### FIG. 24: Example Computing Device

FIG. 24 is a block diagram that illustrates an example computing device 2400 which may be used to implement one or more features described herein, in accordance with some implementations. In one example, computing device 2400 may be used to implement a computer device (e.g., 102 and/or 110 of FIG. 1), and perform appropriate method implementations described herein. Computing device 2400 can be any suitable computer system, server, or other electronic or hardware device. For example, the computing device 2400 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 2400 includes a processor 2402, a memory 2404, input/output (I/O) interface 2406, and audio/video input/output devices 2414.

Processor 2402 can be one or more processors and/or processing circuits to execute program code and control basic operations of the computing device 2400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 2404 is typically provided in computing device 2400 for access by the processor 2402, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 2402 and/or integrated therewith. Memory 2404 can store software operating on the computing device 2400 by the processor 2402, including an operating system 2408, a virtual experience application 2410, a CSG modeling application 2412, and other applications (not shown). In some implementations, virtual experience application 2410 and/or CSG modeling application 2412 can include instructions that enable processor 2402 to perform the functions (or control the functions of) described herein, e.g., some or all of the methods described with respect to FIGS. 2B, 3A, 3D, 4A-4B, and 9-10.

For example, virtual experience application 2410 can include a CSG modeling application 2412, which as described herein can produce binary trees defining CSG models corresponding to a groundtruth occupancy function (e.g., 102). Elements of software in memory 2404 can alternatively be stored on any other suitable storage location or computer-readable medium. In addition, memory 2404 (and/or other connected storage device(s)) can store instructions and data used in the features described herein. Memory 2404 and any other type of storage (magnetic disk, optical disk, magnetic tape, or other tangible media) can be considered “storage” or “storage devices.”

I/O interface 2406 can provide functions to enable interfacing the computing device 2400 with other systems and devices. For example, network communication devices, storage devices (e.g., memory and/or data store 120), and input/output devices can communicate via I/O interface 2406. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 2414 can include a user input device (e.g., a mouse, etc.) that can be used to receive user input, a display device (e.g., screen, monitor, etc.) and/or a combined input and display device, that can be used to provide graphical and/or visual output.

For case of illustration, FIG. 24 shows one block for each of processor 2402, memory 2404, I/O interface 2406, and software blocks of operating system 2408, virtual experience application 2410, and CSG modeling application 2412. These blocks may represent one or more processors or processing circuitries, operating systems, memories, I/O interfaces, applications, and/or software engines. In other implementations, computing device 2400 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the computing device 2400, e.g., processor(s) 2402, memory 2404, and I/O interface 2406. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 2414, for example, can be connected to (or included in) the computing device 2400 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., methods 200b, 300a, 300d, 400a, 400b, 900, and 1000) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method, comprising:
obtaining a groundtruth occupancy function descriptive of a three-dimensional (3D) object; and
constructing a constructive solid geometry (CSG) model of the 3D object, the CSG model defined by a binary tree wherein nodes of the binary tree define Boolean operations and leaves of the binary tree define parameters of CSG primitives,
wherein values of the Boolean operations and values of the parameters of the CSG primitives for the binary tree are identified by minimizing an error between an occupancy function of the CSG model and the groundtruth occupancy function of the 3D object.

2. The computer-implemented method of claim 1, wherein the Boolean operations correspond to unified fuzzy Boolean operators that are differentiable with respect to a type of Boolean operator.

3. The computer-implemented method of claim 2, wherein the unified fuzzy Boolean operators are defined by a tetrahedral barycentric interpolation scheme, based on barycentric coordinates that specify a position between binary Boolean operations that define a tetrahedron.

4. The computer-implemented method of claim 1, wherein the CSG primitives are smooth primitives and the CSG model has an adaptive smoothness controlled by changing respective softness of occupancy functions of the smooth primitives.

5. The computer-implemented method of claim 4, wherein the CSG primitives are represented as signed distance functions, and further comprising converting the signed distance functions into occupancy functions using a sigmoid function based on a sharpness parameter.

6. The computer-implemented method of claim 5, wherein the respective softness of the occupancy functions of the smooth primitives is controlled by a temperature parameter of the sigmoid function.

7. The computer-implemented method of claim 1, wherein the groundtruth occupancy function of the 3D object is obtained from a visual hull representation of the 3D object that is generated based on a mesh corresponding to the 3D object.

8. The computer-implemented method of claim 1, further comprising initializing the binary tree with random parameter values, and wherein minimizing the error comprises iteratively modifying the values of the Boolean operations and the values of the parameters of the CSG primitives in the binary tree until the error between the occupancy function of the CSG model and the groundtruth occupancy function of the 3D object is less than a threshold value.

9. The computer-implemented method of claim 8, wherein minimizing the error is performed using adaptive moment estimation (ADAM).

10. The computer-implemented method of claim 1, wherein the CSG primitives are selected from the group comprising: spheres, planes, quadric surfaces, multilayer perceptrons (MLPs), and combinations thereof.

11. The computer-implemented method of claim 1, wherein minimizing the error between an occupancy function of the CSG model and the groundtruth occupancy function of the 3D object comprises updating the values of the Boolean operations and the values of the parameters of the CSG primitives for the binary tree using a machine learning model, wherein the updating comprises:
determining the occupancy function of the CSG model based on the values of the Boolean operations and parameters of the CSG primitives of the CSG model;
computing a difference between the occupancy function of the CSG model and the groundtruth occupancy function of the 3D object; and
modifying values of the Boolean operations and parameters of the CSG primitives of the CSG model based on the difference, wherein the modifying is performed using gradient descent,
wherein the determining, computing, and modifying are performed iteratively until a stopping criterion is met, wherein the stopping criterion is at least one of:
the difference between the occupancy function of the CSG model and the groundtruth occupancy function of the 3D object falling below a threshold,
change between the occupancy function of the CSG model between consecutive iterations falling below a change threshold, or
a computational budget being exhausted.

12. The computer-implemented method of claim 11, wherein computing the difference comprises:
sampling the groundtruth occupancy of the 3D object to identify a plurality of groundtruth points;
determining corresponding modeled points obtained based on the CSG model; and
computing an error by pairwise comparison of points from the plurality of groundtruth points and corresponding modeled points.

13. The computer-implemented method of claim 11, wherein the gradient descent uses Boolean parameterization based on a temperatured SoftMax function to facilitate convergence for the Boolean operations to a single Boolean logic operation.

14. The computer-implemented method of claim 1, further comprising:
pruning the binary tree to remove redundant subtrees to obtain a pruned binary tree by visiting nodes in the tree in post-order and deleting redundant nodes, wherein a node is redundant when replacement of the node with a full object or an empty object results in a difference in an output of a Boolean operation associated with the node in the binary tree that satisfies a threshold.

15. The computer-implemented method of claim 14, further comprising traversing the pruned binary tree using a linear time traversal algorithm on a forward pass in post-order using a stack when using the pruned binary tree to infer properties of the CSG model of the 3D object.

16. A non-transitory computer-readable medium with instructions stored thereon that, responsive to execution by a processing device, cause the processing device to perform operations comprising:
obtaining a groundtruth occupancy function descriptive of a three-dimensional (3D) object; and
constructing a constructive solid geometry (CSG) model of the 3D object, the CSG model defined by a binary tree wherein nodes of the binary tree define Boolean operations and leaves of the binary tree define parameters of CSG primitives,
wherein values of the Boolean operations and values of the parameters of the CSG primitives for the binary tree are identified by minimizing an error between an occupancy function of the CSG model and the groundtruth occupancy function of the 3D object.

17. The non-transitory computer-readable medium of claim 16, wherein the Boolean operations correspond to unified fuzzy Boolean operators that are differentiable with respect to a type of Boolean operator.

18. The non-transitory computer-readable medium of claim 16, wherein the operations further comprise:
initializing the binary tree with random parameter values, and wherein minimizing the error comprises iteratively modifying the values of the Boolean operations and the values of the parameters of the CSG primitives in the binary tree until the error between the occupancy function of the CSG model and the groundtruth occupancy function of the 3D object is less than a threshold value.

19. A system comprising:
a memory with instructions stored thereon; and
a processing device, coupled to the memory, the processing device configured to access the memory and execute the instructions, wherein the instructions cause the processing device to perform operations comprising:
obtaining a groundtruth occupancy function descriptive of a three-dimensional (3D) object; and
constructing a constructive solid geometry (CSG) model of the 3D object, the CSG model defined by a binary tree wherein nodes of the binary tree define Boolean operations and leaves of the binary tree define parameters of CSG primitives,
wherein values of the Boolean operations and values of the parameters of the CSG primitives for the binary tree are identified by minimizing an error between an occupancy function of the CSG model and the groundtruth occupancy function of the 3D object.

20. The system of claim 19, wherein the Boolean operations correspond to unified fuzzy Boolean operators that are differentiable with respect to a type of Boolean operator.
